(19) United States
(12) Patent Application Publication
(10) Pub. No.: US 2025/0020777 A1
(43) Pub. Date: Jan. 16, 2025

(54) CONTROL DEVICE, CONTROL METHOD, AND NON-TRANSITORY COMPUTER-READABLE STORAGE MEDIUM STORING CONTROL PROGRAM

(71) Applicant: DENSO CORPORATION, Kariya-city, Aichi-pref. (JP)

(72) Inventors: Kenichi YANAI, Kariya-city (JP); Hiroshi UESUGI, Kariya-city (JP)

(21) Appl. No.: 18/441,068

(22) Filed: Feb. 14, 2024

Related U.S. Application Data
(63) Continuation of application No. PCT/JP2022/032093, filed on Aug. 25, 2022.

(30) Foreign Application Priority Data
Sep. 14, 2021 (JP) 2021-149661

(51) Int. Cl. G01S 7/48; G01S 17/04; G01S 17/10; G01S 17/89; G01S 17/931

(52) U.S. Cl. CPC G01S 7/4802; G01S 7/4808; G01S 17/04; G01S 17/10; G01S 17/89; G01S 17/931

(57) ABSTRACT

By a control device, a control method, or a non-transitory computer-readable storage medium storing a control program, an optical sensor that detects an echo of irradiation light irradiated to a detection area is controlled, distance image data representing a distance value to a reflective target is acquired, intensity image data representing an intensity value of the echo is acquired, a flare pixel region in which flare imaging is predicted in a periphery of a target pixel region is estimated, and the distance value of the flare pixel region is removed. A detection timing of the echo in the flare pixel region overlaps with a detection timing of the echo in the target pixel region in the distance image data.

### CROSS REFERENCE TO RELATED APPLICATIONS

The present application is a continuation application of International Patent Application No. PCT/JP2022/032093 filed on Aug. 25, 2022, which designated the U.S. and claims the benefit of priority from Japanese Patent Application No. 2021-149661 filed on Sep. 14, 2021. The entire disclosures of all of the above applications are incorporated herein by reference.

### TECHNICAL FIELD

The present disclosure relates to a technology for controlling an optical sensor that detects an echo of irradiation light irradiated onto a detection area of a vehicle.

### BACKGROUND

In a comparative technology, two types of pixels with different sensitivities are provided in order to detect incident light that becomes a reflected echo of irradiation light in a distance measuring device that is an optical sensor. As a result, even under conditions where the amount of incident light is high, it is possible to detect incident light without causing erroneous detection due to saturation in pixels with the low sensitivity.

### SUMMARY

By a control device, a control method, or a non-transitory computer-readable storage medium storing a control program, an optical sensor that detects an echo of irradiation light irradiated to a detection area is controlled, distance image data representing a distance value to a reflective target is acquired, intensity image data representing an intensity value of the echo is acquired, a flare pixel region in which flare imaging is predicted in a periphery of a target pixel region is estimated, and the distance value of the flare pixel region is removed. A detection timing of the echo in the flare pixel region overlaps with a detection timing of the echo in the target pixel region in the distance image data.

### BRIEF DESCRIPTION OF THE DRAWINGS

FIG. 1 is a schematic diagram showing an overall configuration of a detection system according to a first embodiment.

FIG. 2 is a schematic diagram showing a detailed configuration of an optical sensor according to the first embodiment.

FIG. 3 is a block diagram showing a functional configuration of a control device according to the first embodiment.

FIG. 4 is a schematic diagram of a light projector according to the first embodiment.

FIG. 5 is a schematic diagram showing characteristics of a laser diode according to the first embodiment.

FIG. 6 is a time chart showing detection frames according to the first embodiment.

FIG. 7 is a schematic diagram of a light receiver according to the first embodiment.

FIG. 8 is a schematic diagram for illustrating distance image data according to the first embodiment.

FIG. 9 is a schematic diagram for illustrating intensity image data according to the first embodiment.

FIG. 10 is a schematic diagram for illustrating a reflective target in the first embodiment.

FIG. 11 is a graph illustrating optical characteristics according to the first embodiment.

FIG. 12 is a schematic diagram illustrating a flare pixel region according to the first embodiment.

FIG. 13 is a schematic diagram illustrating the flare pixel region according to the first embodiment.

FIG. 14 is a graph for illustrating removal of a distance value according to the first embodiment.

FIG. 15 is a graph for illustrating removal of the distance value according to the first embodiment.

FIG. 16 is a flowchart showing a control flow according to the first embodiment.

FIG. 17 is a block diagram showing a functional configuration of a control device according to a second embodiment.

FIG. 18 is a schematic diagram for illustrating removal of the distance value according to the second embodiment.

FIG. 19 is a flowchart showing a control flow according to the second embodiment.

FIG. 20 is a block diagram showing a functional configuration of a control device according to the third embodiment.

FIG. 21 is a time chart showing detection frames according to the third embodiment.

FIG. 22 is a flowchart showing a control flow according to the third embodiment.

FIG. 23 is a block diagram showing a functional configuration of a control device according to a fourth embodiment.

FIG. 24 is a time chart showing detection frames according to the fourth embodiment.

FIG. 25 is a flowchart showing a control flow according to the fourth embodiment.

FIG. 26 is a flowchart showing a control flow according to the fourth embodiment.

FIG. 27 is a block diagram showing a function configuration of a control device according to a modification.

FIG. 28 is a flowchart showing a control flow according to the modification.

FIG. 29 is a block diagram showing a function configuration of the control device according to the modification.

FIG. 30 is a flowchart showing a control flow according to the modification.

FIG. 31 is a block diagram showing a function configuration of the control device according to the modification.

FIG. 32 is a flowchart showing a control flow according to the modification.

FIG. 33 is a block diagram showing a function configuration of the control device according to the modification.

FIG. 34 is a flowchart showing a control flow according to the modification.

### DETAILED DESCRIPTION

When the reflection intensity of the echo is high, for example, flare may occur due to factors such as unnecessary reflection inside the lens, and the optical sensor may inaccurately image a subject's physique. However, it is difficult to solve such erroneous detection caused by flare using the comparative technology.

One example of the present disclosure provides a control device for preventing an erroneous detection of an optical sensor. Another example of the present disclosure provides a control method for preventing the erroneous detection of the optical sensor. Further, another example of the present disclosure provides a storage medium storing a control program for preventing the erroneous detection of the optical sensor.

According to a first example embodiment, a control device includes: a processor having a memory storing computer program code, wherein the processor having the memory is configured to cause the control device to: control an optical sensor that detects an echo of irradiation light irradiated to a detection area of a vehicle; acquire distance image data representing a distance value to a reflective target that reflects light in the detection area based on the echo that is detected by optical sensor and is an echo of the irradiation light with a first intensity; acquire intensity image data representing an intensity value of the echo reflected from the reflective target in the detection area based on the echo that is detected by the optical sensor and is an echo of the irradiation light with a second intensity lower than the first intensity; estimate a flare pixel region in which flare imaging is predicted in a periphery of a target pixel region in which the reflective target is imaged in the distance image data, based on the intensity image data; and remove the distance value of the flare pixel region, wherein a detection timing of the echo in the flare pixel region overlaps with a detection timing of the echo in the target pixel region in the distance image data.

According to a second example embodiment, a control method is executed by a processor having a memory storing computer program code, wherein the processor having the memory is configured to control an optical sensor that detects an echo of irradiation light irradiated to a detection area of a vehicle. The control method includes: acquiring distance image data representing a distance value to a reflective target that reflects light in the detection area based on the echo that is detected by optical sensor and is an echo of the irradiation light with a first intensity; acquiring intensity image data representing an intensity of the echo reflected from the reflective target in the detection area based on the echo that is detected by the optical sensor and is an echo of the irradiation light with a second intensity lower than the first intensity; estimating a flare pixel region in which flare imaging is predicted in a periphery of a target pixel region in which the reflective target is imaged in the distance image data, based on the intensity image data; and removing the distance value of the flare pixel region, wherein a detection timing of the echo in the flare pixel region overlaps with a detection timing of the echo in the target pixel region in the distance image data.

According to a third example embodiment, a non-transitory computer-readable storage medium stores a control program storing computer program code that when executed by a processor cause the processor to: control an optical sensor that detects an echo of irradiation light irradiated to a detection area of a vehicle; acquire distance image data representing a distance value to a reflective target that reflects light in the detection area based on the echo that is detected by optical sensor and is an echo of the irradiation light with a first intensity; acquire intensity image data representing an intensity of the echo reflected from the reflective target in the detection area based on the echo that is detected by the optical sensor and is an echo of the irradiation light with a second intensity lower than the first intensity; estimate a flare pixel region in which flare imaging is predicted in a periphery of a target pixel region in which the reflective target is imaged in the distance image data, based on the intensity image data; and remove the distance value of the flare pixel region, wherein a detection timing of the echo in the flare pixel region overlaps with a detection timing of the echo in the target pixel region in the distance image data.

According to the first to third example embodiments, the distance image data representing the distance value to the reflective target that reflects light in the detection area is acquired based on the echo detected by the optical sensor with respect to the irradiation light of the first intensity. Therefore, in the first to third example embodiments, based on the echoes detected by the optical sensor with respect to the irradiation light with the second intensity lower than the first intensity, the intensity image data representing intensity value of the echo reflected from the reflective target Tr in the detection area is acquired. Thereby, it is possible to perform appropriate estimation since the flare pixel region of which flare imaging is predicted around the target pixel region with the imaged reflective target in the distance image data based on the intensity image data of which imaging is prevented according to the illumination with the low intensity. Therefore, it is possible to remove, as the spurious value due to the flare imaging, the distance value of the flare pixel region of which echo detection timing overlaps with the target pixel region in the distance image data, and therefore prevent the erroneous detection of the distance value of the optical sensor.

According to a fourth example embodiment, a control device includes: a processor having a memory storing computer program code, wherein the processor having the memory is configured to cause the control device to: control an optical sensor that detects an echo of irradiation light irradiated to a detection area of a vehicle; acquire distance image data representing a distance value to a reflective target that reflects light in the detection area based on the echo that is detected by optical sensor and is an echo of the irradiation light; acquire intensity image data representing an intensity value of the echo reflected from the reflective target in the detection area based on the echo that is detected by the optical sensor and is an echo of background light with a lower intensity than the irradiation light; estimate a flare pixel region in which flare imaging is predicted in a periphery of a target pixel region in which the reflective target is imaged in the distance image data, based on the intensity image data; and remove the distance value of the flare pixel region, wherein a detection timing of the echo in the flare pixel region overlaps with a detection timing of the echo in the target pixel region in the distance image data.

According to a fifth example embodiment, a control method is executed by a processor having a memory storing computer program code, wherein the processor having the memory is configured to control an optical sensor that detects an echo of irradiation light irradiated to a detection area of a vehicle. The control method includes: acquiring distance image data representing a distance value to a reflective target that reflects light in the detection area based on the echo that is detected by optical sensor and is an echo of the irradiation light; acquiring intensity image data representing an intensity value of the echo reflected from the reflective target in the detection area based on the echo that is detected by the optical sensor and is an echo of background light with a lower intensity than the irradiation light; estimating a flare pixel region in which flare imaging is predicted in a periphery of a target pixel region in which the reflective target is imaged in the distance image data, based on the intensity image data; and removing the distance value of the flare pixel region, wherein a detection timing of the echo in the flare pixel region overlaps with a detection timing of the echo in the target pixel region in the distance image data.

According to a sixth example embodiment, a non-transitory computer-readable storage medium stores a control program storing computer program code that when executed by a processor cause the processor to: control an optical sensor that detects an echo of irradiation light irradiated to a detection area of a vehicle; acquire distance image data representing a distance value to a reflective target that reflects light in the detection area based on the echo that is detected by optical sensor and is an echo of the irradiation light; acquire intensity image data representing an intensity value of the echo reflected from the reflective target in the detection area based on the echo that is detected by the optical sensor and is an echo of background light with a lower intensity than the irradiation light; estimate a flare pixel region in which flare imaging is predicted in a periphery of a target pixel region in which the reflective target is imaged in the distance image data, based on the intensity image data; and remove the distance value of the flare pixel region, wherein a detection timing of the echo in the flare pixel region overlaps with a detection timing of the echo in the target pixel region in the distance image data.

According to the fourth to sixth example embodiments, the distance image data representing the distance value to the reflective target that reflects light in the detection area is acquired based on the echo detected by the optical sensor with respect to the irradiation light. Therefore, in the fourth to sixth example embodiments, based on the echoes detected by the optical sensor with respect to the background light with the lower intensity that the irradiation light in the detection area, the intensity image data representing intensity value of the echo reflected from the reflective target Tr in the detection area is acquired. Thereby, it is possible to perform appropriate estimation since the flare pixel region of which flare imaging is predicted around the target pixel region with the imaged reflective target in the distance image data is based on the intensity image data of which imaging is prevented according to the background light with the low intensity. Therefore, it is possible to remove, as the spurious value due to the flare imaging, the distance value of the flare pixel region of which echo detection timing overlaps with the target pixel region in the distance image data, and therefore prevent the erroneous detection of the distance value of the optical sensor.

The following will describe multiple embodiments of the present disclosure with reference to the drawings.

### First Embodiment

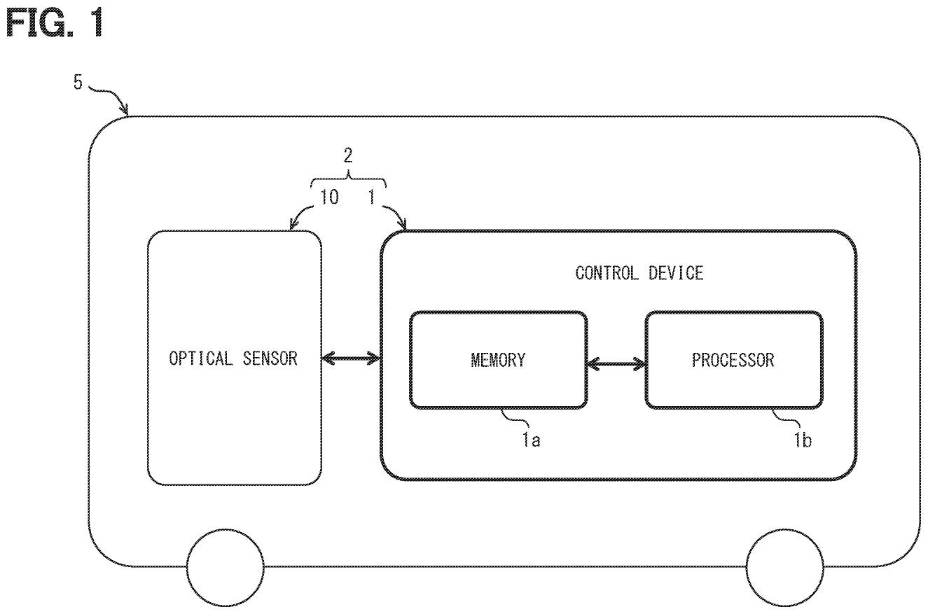

As shown in FIG. 1, a first embodiment of the present disclosure relates to a detection system 2 that includes an optical sensor 10 and a control device 1. The detection system 2 is mounted on a vehicle 5. The vehicle 5 is a mobile body such as an automobile that can travel on a traveling path in a boarding state of an occupant.

The vehicle 5 is capable of executing a constant or temporary automated traveling in an automated driving control mode. Here, the automated driving control mode may be achieved with an autonomous operation control, such as conditional driving automation, advanced driving automation, or full driving automation, where the system in operation performs all driving tasks. The automated driving control mode may be achieved with an advanced driving assistance control, such as driving assistance or partial driving automation, where the occupant performs some or all driving tasks. The automated driving control mode may be achieved by any one, combination, or switching of autonomous driving control and advanced driving assistance control.

In the following description, unless otherwise specified, each direction of the front, the rear, the top, the bottom, the left, and the right is defined with respect to the vehicle 5 on a horizontal plane. Further, a horizontal direction refers to a parallel direction that is also a lateral direction with respect to a horizontal plane that serves as a direction reference for the vehicle 5. Furthermore, a vertical direction refers to a direction perpendicular to a horizontal plane serving as a direction reference for the vehicle 5.

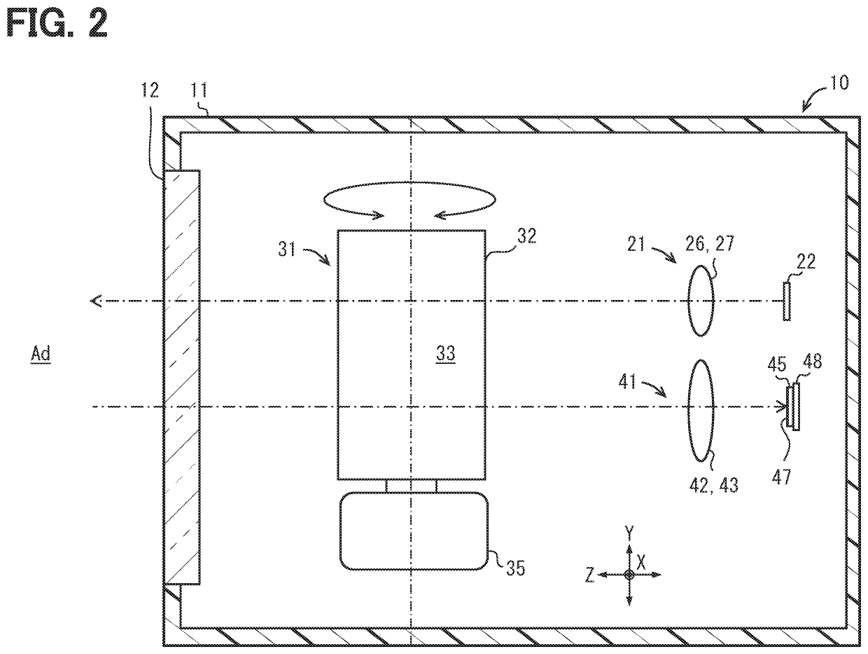

The optical sensor 10 is a so-called LiDAR (Light Detection and Ranging/Laser Imaging Detection and Ranging) for acquiring image data that can be used for driving control of the vehicle 5 including automated control driving mode. The optical sensor 10 is disposed at at least one location in the vehicle 5, for example, among a front portion, a side portion on a left or a right, a rear portion, an upper roof, and the like. As shown in FIG. 2, in the optical sensor 10, a three-dimensional orthogonal coordinate system is defined by three mutually orthogonal axes: an X-axis, a Y-axis, and a Z-axis. Particularly in this embodiment, the X-axis and the Z-axis are set along different horizontal directions of the vehicle 5, and the Y-axis is set along the vertical direction of the vehicle 5. In addition, in FIG. 2, the left part with respect to the dashed-dot line along the Y axis (a part close to a light-transmitting cover 12, which will be described later) is a cross section actually perpendicular to the right part with respect to the dashed-dotted line (a part close to unit 21, 41, which will be described later).

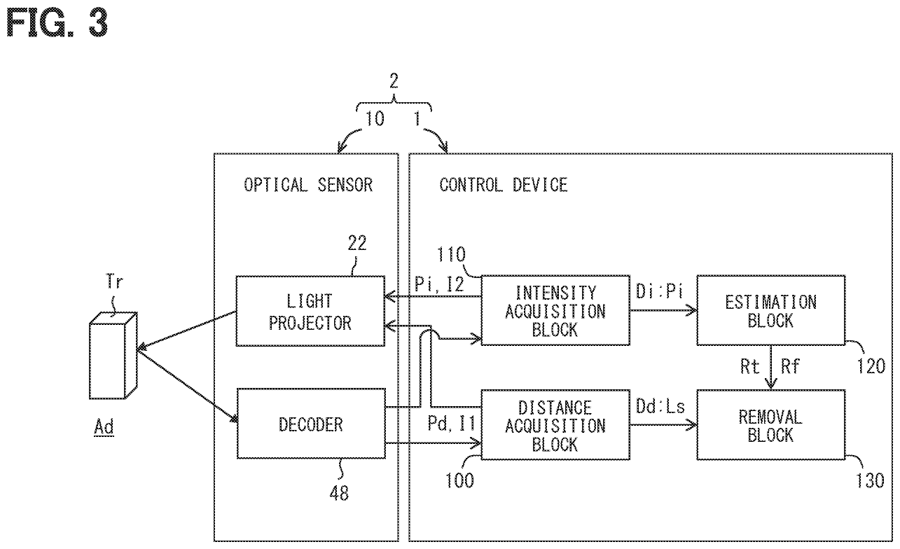

As shown in FIG. 3, the optical sensor 10 irradiates light toward a detection area Ad corresponding to the location in the external space of the vehicle 5. The optical sensor 10 detects the reflected light incident upon the irradiated light being reflected from the detection area Ad as an echo from the detection area Ad. The optical sensor 10 can also detect, as an echo from the detection area Ad, incident light obtained by reflecting background light (that is, external light) from the detection area Ad when the irradiation light is not irradiated.

The optical sensor 10 observes a reflective target Tr that reflects light within the detection area Ad by detecting such echoes. In particular, observation in this embodiment means sensing the distance value from the optical sensor 10 to the reflective target Tr and the intensity value of the echo reflected from the reflective target Tr. A typical observation target to be observed in the optical sensor 10 applied to the vehicle 5 may be at least one type of mobile object such as a pedestrian, a cyclist, an animal other than a human, or another vehicle. The typical target to be observed in the optical sensor 10 applied to the vehicle 5 is at least one type of stationary object such as a guardrail, a road sign, a structure on a road side, or a fallen object on the road.

As shown in FIG. 2, the optical sensor 10 includes a housing 11, a light projection unit 21, a scanning unit 31, and a light reception unit 41. The housing 11 constitutes the exterior of the optical sensor 10. The housing 11 is formed in a box shape and has light blocking properties. The housing 11 accommodates the light projection unit 21, the scanning unit 31, and the light reception unit 41 therein. A light-transmitting cover 12 is provided on an open optical window of the housing 11. The light-transmitting cover 12 is formed in a plate shape and has light-transmitting properties for the above-mentioned irradiation light and echoes. The light-transmitting cover 12 closes the optical window of the housing 11 so that both the irradiation light and the echo can pass therethrough.

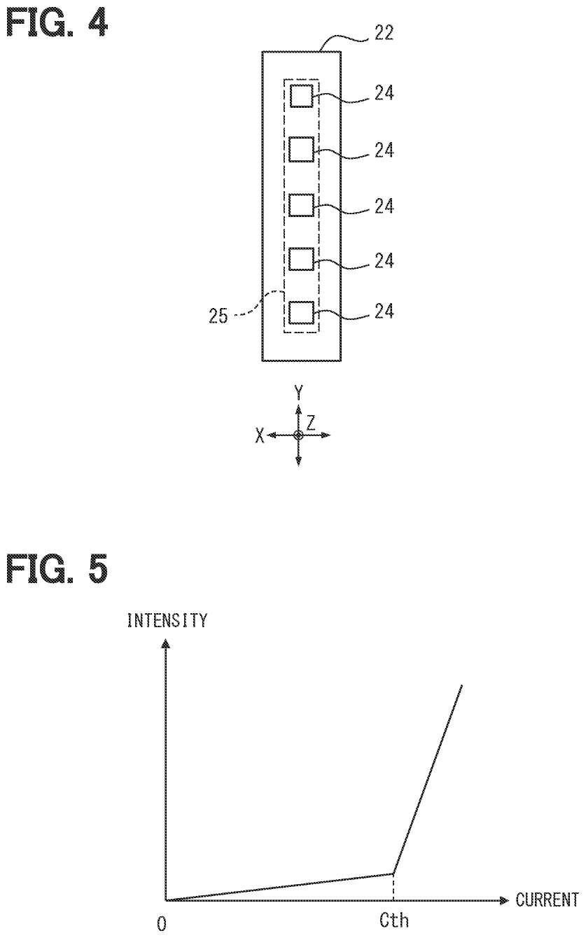

The light projection unit 21 includes a light projector 22 and a light projection lens system 26. The light projector 22 is arranged within the housing 11. As shown in FIG. 4, the light projector 22 is formed by arranging a plurality of laser diodes 24 in an array on a substrate. Each laser diode 24 is arranged in a single row along the Y-axis. Each laser diode 24 has a resonator structure that can resonate light oscillated in a PN junction layer, and a mirror layer structure that can repeatedly reflect light with the PN junction layer in between.

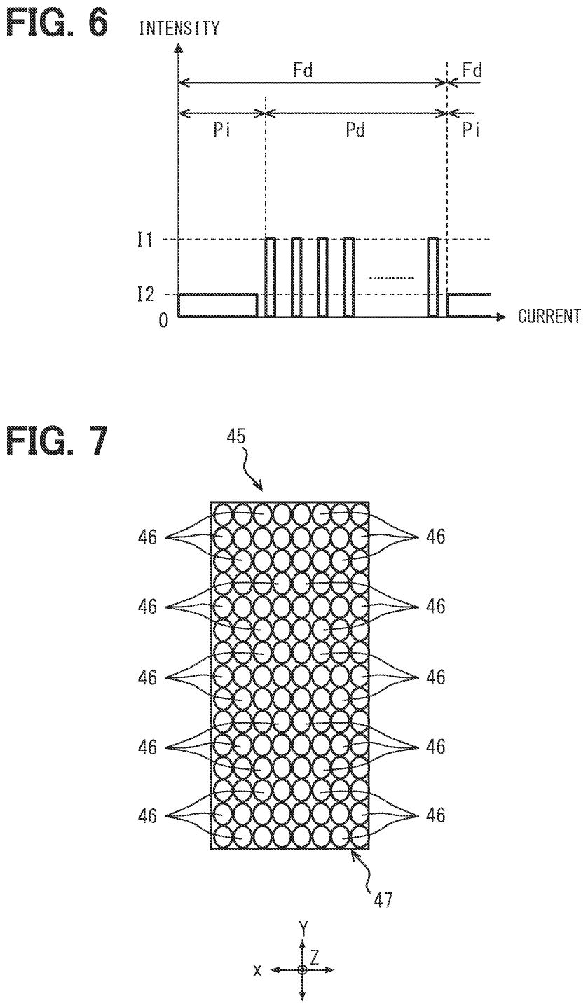

Each laser diode 24 emits light in accordance with the application of a current according to a control signal from the control device 1. In particular, each of the laser diodes 24 of this embodiment emits light in the near-infrared region that is difficult to see for people present in the external space of the vehicle 5. As shown in FIG. 5, when a current higher than a switching current value Cth is applied to each laser diode 24, the laser diode 24 enters an LD (Laser Diode) mode, which is an oscillation state, and emits pulsed light. The light emitted from each of the laser diodes 24 in the LD mode constitutes irradiation light having a first intensity I1 in a near-infrared region, as shown in FIG. 6. On the other hand, as shown in FIG. 5, when a current lower than the switching current value Cth is applied to each laser diode 24, the laser diode 24 enters a LED (Light Emitting Diode) mode of a non-oscillation state, and emits DC (Direct current). The light emitted from each laser diode 24 in such an LED mode constitutes irradiation light with a second intensity I2 whose intensity in the near-infrared region is lower than the first intensity I1, as shown in FIG. 6.

As shown in FIG. 4, the light projector 22 has a light projection window 25 formed on one side of the substrate, the long side of which is pseudo-defined with a rectangular outline along the Y-axis. The light projection window 25 is configured as a collection of projection apertures in each laser diode 24. The light emitted from the projection aperture of each laser diode 24 is projected from the light projection window 25 in the detection area Ad as irradiation light regarded as the shape of a longitudinal line along the Y-axis. The irradiation light may include a no-light-emission portion corresponding to the arrangement interval of each laser diode 24 in the Y-axis direction. Even in this case, it is preferable to form line-shaped irradiation light for which the no-light-emission portion is macroscopically eliminated in the detection area Ad due to a diffraction effect.

As shown in FIG. 2, the light projection lens system 26 projects the irradiation light from the light projector 22 toward a scanning mirror 32 of the scanning unit 31. The light projection lens system 26 is placed within the housing 11 between the light projector 22 and the scanning mirror 32. The light projection lens system 26 provides at least one type of optical function among, for example, condensing, collimating, and shaping. The light projection lens system 26 forms a light projection optical axis along the Z-axis. The light projection lens system 26 has at least one light projection lens 27 having a lens shape corresponding to the optical effect to be exerted on the light projection optical axis. The light projector 22 is positioned on the light projection optical axis of the light projection lens system 26. Irradiation light emitted from the center of the light projection window 25 in the light projector 22 is guided along the light projection optical axis of the light projection lens system 26.

The scanning unit 31 includes the scanning mirror 32 and a scanning motor 35. The scanning mirror 32 scans the irradiation light emitted from the light projection lens system 26 of the light projection unit 21 toward the detection area Ad, and reflects the echo from the detection area Ad toward a light reception lens system 42 of the light reception unit 41. The scanning mirror 32 is placed between the light-transmitting cover 12 and the light projecting lens system 26 on the optical path of the irradiation light, and between the light-transmitting cover 12 and the light reception lens system 42 on the optical path of the echo.

The scanning mirror 32 is formed into a plate shape by depositing a reflective film on a reflective surface 33, which is one side of a base material. The scanning mirror 32 is supported by the housing 11 so as to be rotatable around (in other words, in a periphery of) a rotation center line along the Y-axis. The scanning mirror 32 can adjust the normal direction of the reflective surface 33 by rotating around the rotation center line. The scanning mirror 32 swings within a driving range limited by a mechanical or electrical stopper.

The scanning mirror 32 is provided in common to the light projection unit 21 and the light reception unit 41. That is, the scanning mirror 32 is provided in common for the irradiation light and the echo. Thereby, the scanning mirror 32 forms a light emission reflective surface portion used for reflecting irradiation light and a light reception reflective surface portion used for reflecting echoes so as to be shifted in the Y-axis direction in the reflective surface 33.

The irradiation light is reflected from the light emission reflective surface portion of the reflective surface 33 facing the normal direction according to the rotation of the scanning mirror 32, and is transmitted through the light-transmitting cover 12, so that the detection area Ad is temporally and spatially scanned. At this time, the scanning of the detection area Ad by the irradiation light is substantially limited to scanning in the horizontal direction. The irradiation light and the background light are reflected by the reflective target Tr existing in the detection area Ad and enter the optical sensor 10 as the echo. The echo passes through the light-transmitting cover 12 and is reflected from the light reception and reflective surface portions at the reflective surface 33 that faces in the normal direction according to the rotation of the scanning mirror 32. Thereby, the echo is guided to the light reception lens system 42 of the light reception unit 41. Here, the speed of the irradiation light and the echo are sufficiently large relative to the rotational speed of the scanning mirror 32. Thereby, the echo of the irradiation light is guided to the light reception lens system 42 in a direction opposite to the irradiation light at the scanning mirror 32 having substantially the same rotation angle as the irradiation light.

The scanning motor 35 is placed around the scanning mirror 32 within the housing 11. The scanning motor 35 is, for example, a voice coil motor, a direct current motor with brushes, a stepping motor, or the like. The scanning motor 35 rotates (i.e. swings) the scanning mirror 32 within a finite driving range according to a control signal from the control device 1.

The light reception unit 41 includes the light reception lens system 42 and a light receiver 45. The light reception lens system 42 guides the echo reflected by the scanning mirror 32 toward the light receiver 45. The light reception lens system 42 is placed between the scanning mirror 32 and the light receiver 45 within the housing 11. The light reception lens system 42 is positioned below the light projection lens system 26 in the Y-axis direction. The light reception lens system 42 provides an optical function so as to form an image of an echo on the light receiver 45. The light reception lens system 42 forms a light reception optical axis along the Z-axis. The light reception lens system 42 has at least one light reception lens 43 on the light reception optical axis, which has a lens shape depending on the optical effect to be exerted. The echo reflected from the light reception and reflective surface portions of the reflective surface 33 of the scanning mirror 32 from the detection area Ad is guided along the light reception optical axis of the light reception lens system 42 within the driving range of the scanning mirror 32.

The light receiver 45 receives the echo from the detection area Ad imaged by the light reception lens system 42, and outputs a detection signal corresponding to the received light. The light receiver 45 is placed within the housing 11 on the opposite side of the scanning mirror 32, and the light receiver 45 and the scanning mirror 32 sandwiches the light reception lens system 42. The light receiver 45 is positioned below the light projector 22 in the Y-axis direction and on the light reception optical axis of the light reception lens system 42.

As shown in FIG. 7, the light receiver 45 is formed by arranging light reception elements 46 on a substrate in a two-dimensional array in the X-axis direction and the Y-axis direction. Each light reception element 46 includes a plurality of light reception elements. That is, since a plurality of light reception elements correspond to each light reception element 46, the output value differs depending on the number of responses of these light reception elements. The light reception element of each light reception element 46 mainly includes a photodiode such as a single photon avalanche diode (SPAD), for example. The light reception element of each light reception element 46 may be integrally constructed by stacking a micro lens array in front of the photodiode array.

The light receiver 45 has a light reception surface 47 with a rectangular outline formed on one side of the substrate. The light reception surface 47 is configured as a collection of incident surfaces of each light reception element 46. A geometric center of the rectangular outline of the light reception surface 47 is aligned on the light reception optical axis of the light reception lens system 42 or slightly shifted from the light reception optical axis of the light reception lens system 42. Each light reception element 46 receives the echo that has entered the light reception surface 47 from the light reception lens system 42 using its respective light reception element. Here, the long side of the light reception surface 47 forming a rectangular outline is defined along the Y-axis. Thereby, in response to the line-shaped irradiation light in the detection area Ad, echoes of the irradiation light are received by the light reception elements of each light reception element 46 as a linearly spread beam.

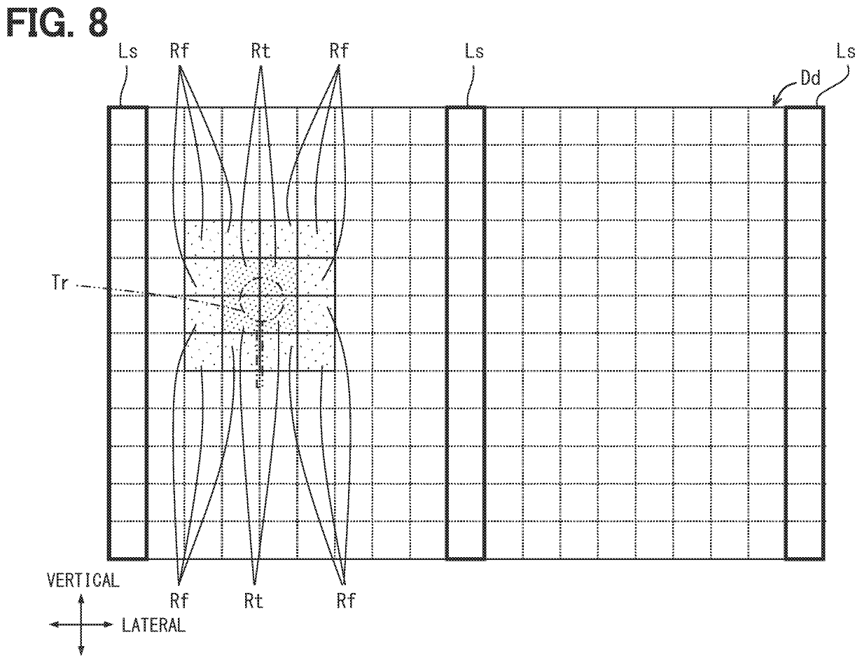

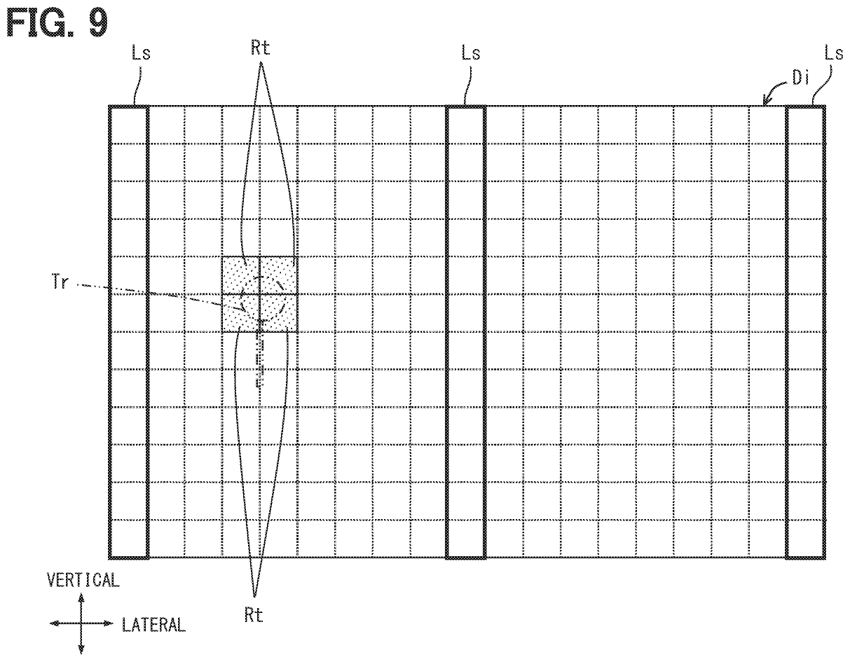

As shown in FIG. 2, the light receiver 45 integrally includes a decoder 48. The decoder 48 sequentially reads out electric pulses generated by each light reception element 46 in response to the reception of the echo on the light reception surface 47 by sampling processing. The decoder 48 outputs the sequentially read electric pulses to the control device 1 as a detection signal in the detection frame (that is, detection cycle) Fd shown in FIG. 6. At this time, the detection frame Fd is repeated at predetermined time intervals while the vehicle 5 is being activated. The control device 1 receiving the detection signal of the decoder 48 acquires, as shown in FIGS. 8 and 9, image data Dd and Di representing a target object observation result within the detection area Ad based on the physical quantity regarding the echoes detected by each light reception element 46 as the scanning mirror 32 rotates. In the acquired image data Dd, Di, the vertical direction corresponds to the Y-axis direction of the vehicle 5, and the lateral direction corresponds to the X-axis direction of the vehicle 5.

The control device 1 shown in FIG. 1 is connected to the optical sensor 10 via at least one of, for example, a LAN (Local Area Network), a wire harness, and an internal bus. The control device 1 includes at least one dedicated computer. The dedicated computer constituting the control device 1 may be a sensor ECU (Electronic Control Unit) specialized for controlling the optical sensor 10. In this case, the sensor ECU may be housed in the housing 11. The dedicated computer constituting the control device 1 may be a driving control ECU that controls the driving of the vehicle 5. The dedicated computer constituting the control device 1 may be a navigation ECU that navigates a travel route of the vehicle 5. The dedicated computer constituting the control device 1 may be a locator ECU that estimates a self-state quantity of the vehicle 5.

The dedicated computer constituting the control device 1 has at least one memory 1a and at least one processor 1b. The memory 1a is at least one type of non-transitory tangible storage medium out of, for example, a semiconductor memory, a magnetic medium, an optical medium, and the like that non-transitorily store a computer readable program, data, and the like. For example, the processor 1b may include, as a core, at least one of a central processing unit (CPU), a graphics processing unit (GPU), a reduced instruction set computer (RISC) CPU, a data flow processor (DFP), a graph streaming processor (GSP), or the like.

The processor 1b executes multiple instructions (for example, computer program code) included in a control program stored in the memory 1a. Thereby, the control device 1 constructs a plurality of functional blocks for controlling the optical sensor 10. In this manner, in the control device 1, the control program stored in the memory 1a for controlling the optical sensor 10 causes the processor 1b to execute a plurality of instructions, thereby constructing a plurality of functional blocks. The plurality of functional blocks constructed by the control device 1 include a distance acquisition block 100, an intensity acquisition block 110, an estimation block 120, and a removal block 130, as shown in FIG. 3.

The distance acquisition block 100 controls the optical sensor 10 to enter the LD mode in which each laser diode 24 is in an oscillation state during a distance acquisition period Pd set in the detection frame Fd shown in FIG. 6. By controlling to the LD mode, the detection area Ad is irradiated with the irradiation light of the first intensity I1 in an intermittent pulse form from the optical sensor 10. Therefore, the distance acquisition block 100 acquires the distance image data Dd of a three-dimensional point group shown in FIG. 8 so as to represent the distance value to the reflective target Tr in the detection area Ad based on the echo detected by the optical sensor 10 in response to the irradiation light of the first intensity I1. At this time, the distance value as each pixel value constituting the distance image data Dd is acquired by dTOF (direct time of flight) based on the flight time of light from pulse irradiation to detection of an echo.

Along with the acquisition of the distance image data Dd, the distance acquisition block 100 also controls rotational drive of the scanning mirror 32 by the scanning motor 35 in synchronization with the pulse irradiation of the irradiation light. Therefore, the distance acquisition block 100 generates the distance image data Dd for each scanning line Ls according to the rotation angle of the scanning mirror 32, and therefore can synthesize the distance image data Dd for each scanning line Ls during the distance acquisition period Pd. Here, the scanning lines Ls regarding the distance image data Dd are set as pixel columns in the vertical direction corresponding to the Y-axis direction, and in a plurality of columns in the horizontal direction corresponding to the X-axis direction.

The intensity acquisition block 110 shown in FIG. 3 controls the optical sensor 10 to be in the LED mode in which each laser diode 24 is in the non-oscillation state during an intensity acquisition period Pi that is set before the distance acquisition period Pd in the detection frame Fd shown in FIG. 6. By controlling to the LED mode, the detection area Ad is continuously irradiated with irradiation light having a second intensity I2 lower than the first intensity I1 from the optical sensor 10. Therefore, the intensity acquisition block 110 acquires two-dimensional intensity image data Di that is shown in FIG. 9 and represents the intensity value of reflection from the reflective target Tr in the detection area Ad based on the echo detected by the optical sensor 10 with respect to the irradiation light with the second intensity I2.

Along with the acquisition of the intensity image data Di, the intensity acquisition block 110 also controls the rotational drive of the scanning mirror 32 by the scanning motor 35 in parallel with the continuous irradiation of the irradiation light. Therefore, the intensity acquisition block 110 generates the intensity image data Di for each scanning line Ls according to the rotation angle of the scanning mirror 32, and therefore can synthesize the intensity image data Di for each scanning line Ls during the intensity acquisition period Pi. Here, as shown in FIG. 9, the scanning line Ls of the intensity image data Di is set to correspond to the scanning line Ls of the distance image data Dd shown in FIG. 8 in the same way and in a 1:1 ratio. In FIGS. 8 and 9, only the first, center, and last scanning lines Ls in the image data Dd and Di are shown by thick line frames, and the other scanning lines Ls are omitted from the figures.

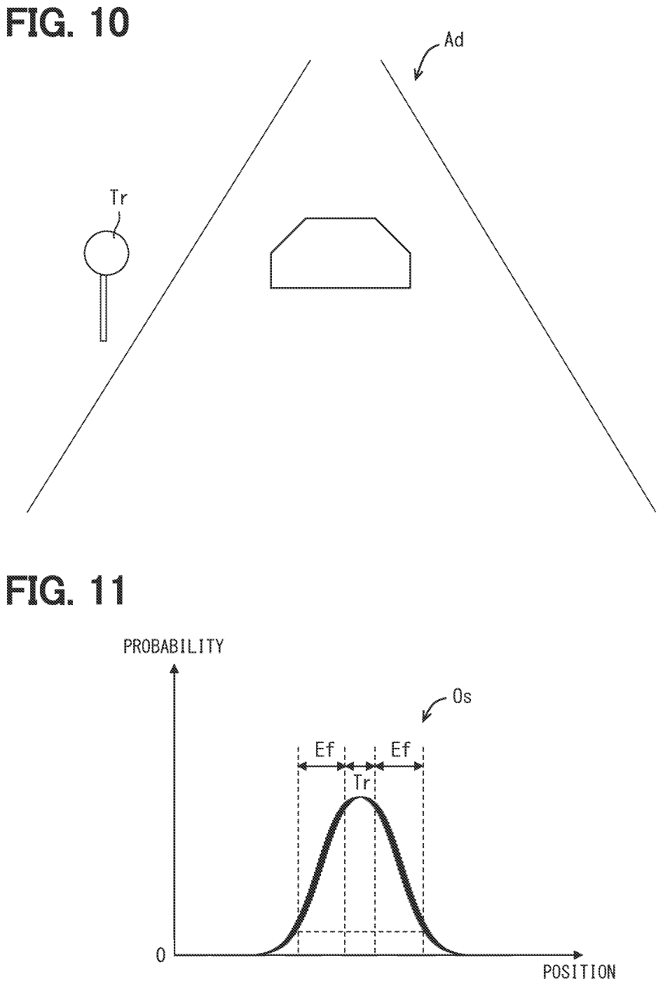

The estimation block 120 shown in FIG. 3 searches a target pixel region Rt in which the reflective target Tr is imaged, from the intensity image data Di obtained by synthesizing data of each scanning line Ls for the intensity acquisition period Pi, as shown in FIG. 9. Here, the target pixel region Rt is defined as a pixel region representing an intensity value that is equal or more that a prediction threshold at which flare occurrence is predicted due to strong reflection of the irradiation light with the first intensity I1 corresponding to the distance image data Dd from the reflective target Tr such as a sign, as shown in FIG. 10. The first embodiment to which this definition is applied is based on a premise that flare imaging is prevented as much as possible for the irradiation light having the second intensity I2 corresponding to the intensity image data Di.

Therefore, as shown in FIGS. 8 and 9, the estimation block 120 estimates a flare pixel region Rf in which the flare is predicted to be imaged around the target pixel region Rt where the reflective target Tr is imaged in the distance image data Dd, based on the intensity value of the target pixel region Rt in the intensity image data Di. In FIGS. 8 and 9, the reflective target Tr in which flare is predicted to occur is virtually indicated by a two-dot chain line, so that the reflective target Tr and each region Rt, Rf are schematically associated with each other.

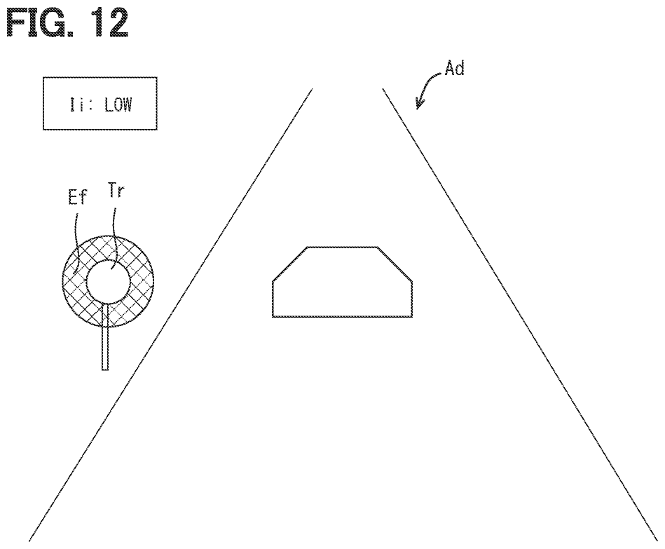

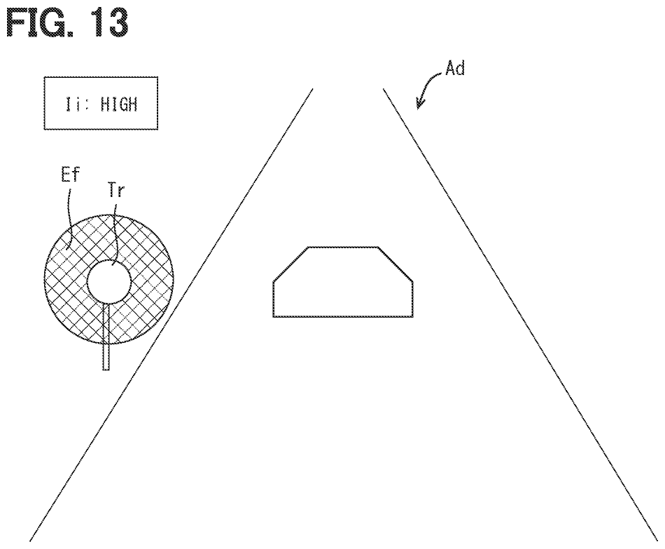

Specifically, the estimation block 120 estimates the flare pixel region Rf that is correlated with an optical characteristic Os of the light reception lens system 42 in the optical sensor 10 and the intensity value of the target pixel region Rt in the intensity image data Di. Here, the optical characteristic Os gives a range Ef in which the probability of flare occurrence around the reflective target Tr is equal to or greater than a set value, as shown in FIG. 11. Therefore, the optical characteristic Os is stored in the memory 1a as, for example, a functional formula or a table, so as to give the range Ef according to an incident intensity Ii of the echo to the light reception lens system 42, as shown by cross hatching in FIGS. 12 and 13. Here, the incident intensity Ii of the echo to the light reception lens system 42 according to the first intensity I1 is estimated from, for example, a representative value or an average value of the intensity value of the target pixel region Rt according to the second intensity I2.

From these, it is estimated that the estimation block 120 extracts, as the flare pixel region Rf, a pixel region estimated to correspond to, in the distance image data Dd, the range Ef that correlates with the optical characteristic Os of the light reception lens system 42 and the intensity value of the target pixel region Rt in the intensity image data Di. Such estimation of the flare pixel region Rf can be considered as estimation of the distance image data Dt acquired for each scanning line Ls, and also as estimation of the distance image data Dd synthesized for each scanning line Ls for the distance acquisition period Pd.

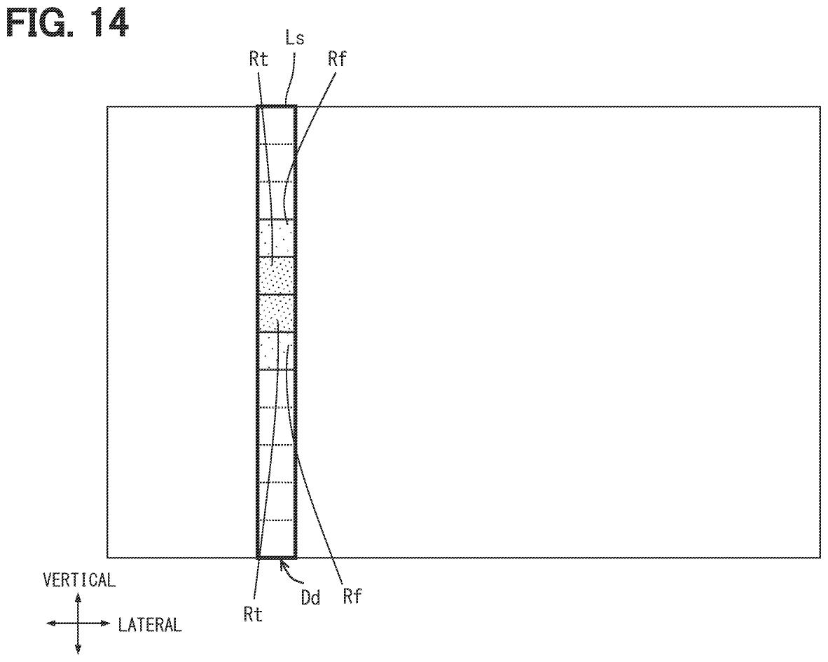

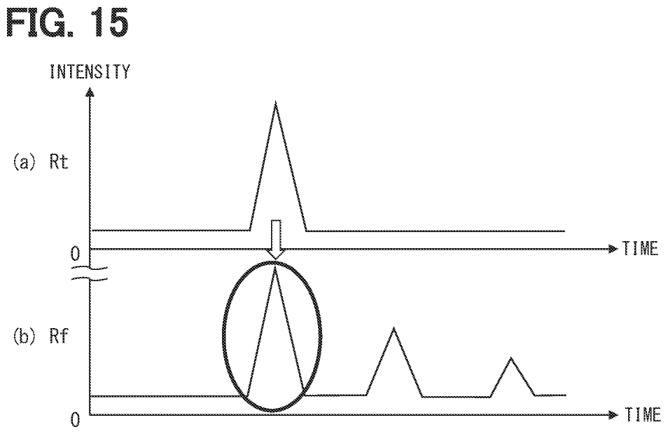

In the first embodiment, the removal block 130 shown in FIG. 3 extracts the distance image data Dd of the scanning line Ls where the flare pixel region Rf is estimated, as shown in FIG. 14, from the distance image data Dd of each scan line Ls. In the distance image data Dd of the extracted scanning line Ls, the removal block 130 removes, as a spurious value, the distance value of the flare pixel region Rf with the echo detection timing overlapping with that of the target pixel region Rt, as shown by a thick ellipse in a surrounded manner in FIG. 15. In this case, the removal means deleting the point group representing the distance value of the corresponding flare pixel region Rf from the distance image data Dd. Further, in this case, the overlapping means that the peak point of the echo is detected within a predetermined error range, so that the intensity waveforms of the echoes above the baseline overlap with each other. Here, in the dTOF applied to the optical sensor 10, the echo detection timing and the distance value correspond in a 1:1 ratio. Therefore, the removal of the distance value according to the detection timing is substantially synonymous with removal of the distance value of the flare pixel region Rf when the difference between the distance value of the flare pixel region Rf and the distance value of the target pixel region Rt is within a predetermined error range.

The removal block 130 synthesizes the distance image data Dd from which the distance value of the flare pixel region Rf has been removed for each scanning line Ls for the distance acquisition period Pd. Therefore, the removal block 130 may store the distance image data Dd from which the distance value of the flare pixel region Rf has been removed in the memory 1a in association with at least one type of time stamp, traveling environment information of the vehicle 5, or the like, for example. Therefore, the removal block 130 may transmit the distance image data Dd from which the distance value of the flare pixel region Rf has been removed to an external center in association with at least one type of time stamp, traveling environment information of the vehicle 5, or the like, for example, for storing it a storage medium of the external center.

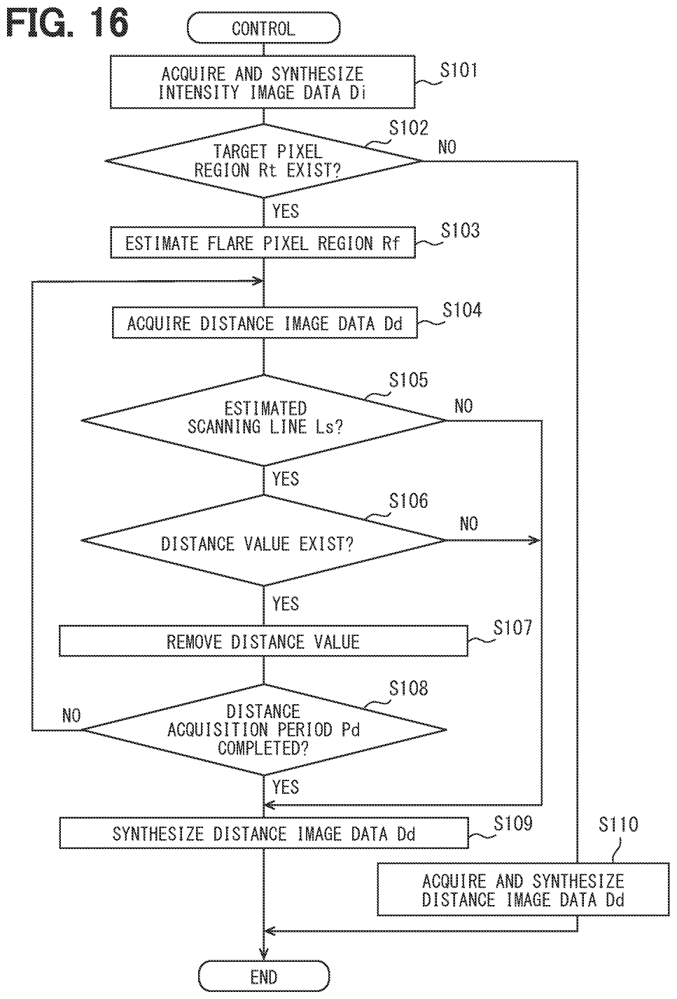

The control method in which the control device 1 controls the optical sensor 10 of the vehicle 5 by the cooperation of the blocks 100, 110, 120, and 130 described so far is executed according to the control flow shown in FIG. 16. This control flow is repeatedly executed for each detection frame Fd while the vehicle 5 is being activated. Each “S” in the control flow indicates one or more processes executed by one or more instructions included in the control program.

In S101, the intensity acquisition block 110 acquires the intensity image data Di representing the intensity value of the echo from the reflective target Tr for the irradiation light of the second intensity I2 during the intensity acquisition period Pi of the current detection frame Fd. At this time, the intensity image data Di for each scanning line Ls is synthesized for the intensity acquisition period Pi.

In subsequent S102, the estimation block 120 determines whether the target pixel region Rt representing an intensity value equal to or greater than the prediction threshold exists in the intensity image data Di. As a result, when an affirmative determination is made, the control flow proceeds to S103.

In S103, the estimation block 120 estimates the flare pixel region Rf of the distance image data Dd based on the intensity value of the target pixel region Rt in the intensity image data Di. At this time, the flare pixel region Rf is estimated in a range Ef that correlates with the optical characteristic Os of the light reception lens system 42 and the intensity value of the target pixel region Rt in the intensity image data Di.

In subsequent S104, the distance acquisition block 100 acquires, for each scanning line Ls with respect to the irradiation light of the first intensity I1, the distance image data Dd representing the distance value to the reflective target Tr for the distance acquisition period Pd of the current detection frame Fd. Therefore, in S105, which is transferred in the control flow every time the distance image data Dd of each scan line Ls is acquired, the removal block 130 determines whether the acquired scanning line Ls of the distance image data Dd is the scan line Ls in which the flare pixel region Rf was estimated in S103. As a result, when an affirmative determination is made, the control flow proceeds to S106.

In S106, the removal block 130 determines whether there is a distance value of the flare pixel region Rf whose echo detection timing overlaps with the target pixel region Rt in the distance image data Dd of the estimated scanning line Ls of the flare pixel region Rf. As a result, when an affirmative determination is made, the control flow proceeds to S107. In S107, the removal block 130 removes as the spurious value, the distance value of the flare pixel region Rf whose echo detection timing overlaps with the target pixel region Rt from the distance image data Dd of the estimated scanning line Ls of the flare pixel region Rf.

When the execution of S107 is completed, and when a negative determination is made in each of S105 and S106, the control flow proceeds to S108. In S108, the distance acquisition block 100 determines whether the distance acquisition period Pd has been completed. As a result, when a negative determination is made, the control flow returns to S104 by the distance acquisition block 100, and the distance image data Dd is acquired for the next uncompleted scanning line Ls. On the other hand, when an affirmative determination is made, the control flow proceeds to S109 by the removal block 130, and the distance for each scanning line Ls, including the distance image data Dd of the scanning line Ls from which pseudo values have been removed, is synthesized for the distance acquisition period Pd. When the execution of S109 is completed, the current execution of the control flow ends.

When a negative determination is made in S102, the control flow proceeds to S110. In this S110, the distance acquisition block 100 acquires the distance image data Dd for the intensity acquisition period Pi of the detection frame Fd for each scanning line Ls as in S104, and then combines them as in S109. When the execution of S110 is completed, the current execution of the control flow ends.

### (Operation Effects)

The operation effects of the first embodiment will be described below.

According to the first embodiment, the distance image data Dd representing the distance value to the reflective target Tr that reflects light in the detection area Ad is acquired based on the echo detected by the optical sensor 10 with respect to the irradiation light of the first intensity I1. Therefore, in the first embodiment, based on the echoes detected by the optical sensor 10 with respect to the irradiation light with the second intensity I2 lower than the first intensity I1, the intensity image data Di representing intensity value of the echo reflected from the reflective target Tr in the detection area Ad is acquired. Thereby, it is possible to perform appropriate estimation since the flare pixel region Rf of which flare imaging is predicted around the target pixel region Rt with the imaged reflective target Tr in the distance image data Dd is based on the intensity image data Di of which imaging is prevented according to the illumination with the low intensity. Therefore, the distance value of the flare pixel region Rf of which echo detection timing overlaps with the target pixel region Rt in the distance image data Dd can be removed as the pseudo value due to flare imaging. Thereby, it is possible to prevent erroneous detection of the distance value by the optical sensor 10.

According to the first embodiment, the distance image data Dd for the irradiation light with the first intensity I1 is acquired from the laser diode 24 controlled to be in the oscillation state in the optical sensor 10. Therefore, according to the first embodiment, the intensity image data Di for the irradiation light with the second intensity I2 is acquired from the laser diode 24 controlled to be in the non-oscillation state in the optical sensor 10. Thereby, it is possible to acquire not only the distance image data Dd, which is a prevention target for false detection, but also the intensity image data Di for estimating the flare pixel region Rf according to the intensity change of the irradiation light from the common laser diode 24. Therefore, by using the relatively small optical sensor 10, it is possible to prevent the erroneous detection of the distance value.

According to the first embodiment, the flare pixel region Rf is estimated in a range Ef that correlates with the optical characteristic Os of the light reception lens system 42 forming the image of the echo in the optical sensor 10 and the intensity value of the target pixel region Rt in the intensity image data Di. Thereby, it is possible to appropriately estimate the flare pixel region Rf in which flare imaging is predicted in the range Ef according to the optical characteristic Os around the target pixel region Rt that can be specified from the intensity value of the intensity image data Di. Therefore, it is possible to accurately remove the distance value of the flare pixel region Rf of which echo detection timing overlaps with the target pixel region Rt in the distance image data Dd, and prevent the erroneous detection of the distance value of the optical sensor 10.

According to the first embodiment, the distance image data Dd is acquired for each of a plurality of scanning lines Ls during the distance acquisition period Pd. On the other hand, the intensity image data Di is acquired for each scanning line Ls during the intensity acquisition period Pi that is earlier than the distance acquisition period Pd. Thereby, based on the intensity image data Di synthesized for each scanning line Ls for the intensity acquisition period Pi, it is possible to remove the distance value as the spurious value from the distance image data Dd limited to the estimated scanning line Ls in which the flare pixel region Rf has been estimated. Therefore, it is possible to prevent erroneous detection of the distance value by the optical sensor 10.

### Second Embodiment

A second embodiment is a modification of the first embodiment.

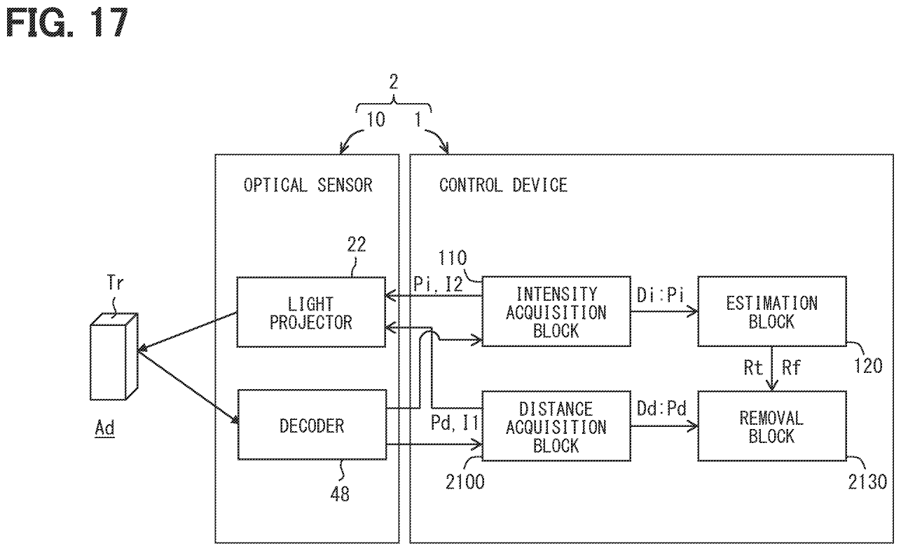

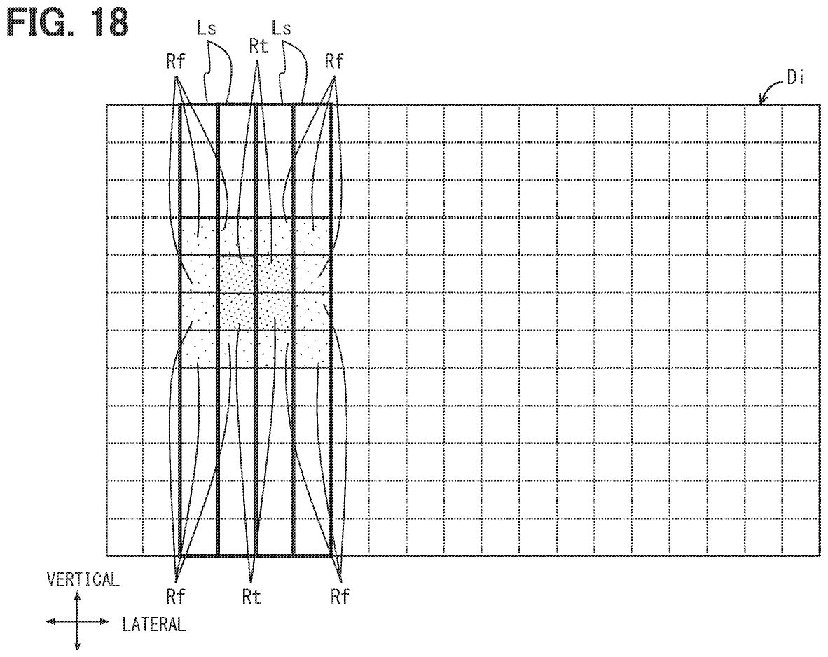

In the second embodiment shown in FIG. 17, the removal block 2130 sets, to the removal target, the distance value of the flare pixel region Rf estimated by the estimation block 120 as shown in FIG. 18 in the distance image data Dd synthesized by the distance acquisition block 2100 for the distance acquisition period Pd for each scanning line Ls. Therefore, the removal block 2130 compares the distance value of the flare pixel region Rf and the distance value of the target pixel region Rt in the synthesized distance image data Dd. At this time, for example, the distance value of the target pixel region Rt set to, for example, a representative value, an average value, or an average value, or the like is compared with the distance value of the flare pixel region Rf such as, for example, a representative value, an average value, a value for each pixel, or the like. In FIG. 18, only the scanning lines Ls that include the removal target in the intensity image data Di are illustrated by thick line frames, and the illustration of the other scanning lines Ls is omitted.

As a result of the comparison, when the difference between the distance value of the flare pixel region Rf and the distance value of the target pixel region Rt falls within a predetermined error range, the removal block 2130 removes the distance value of the flare pixel region Rf. Here, similarly to the first embodiment, in the dTOF applied to the optical sensor 10, the detection timings of the distance value and the echo correspond in a 1:1 ratio. Therefore, removing the distance value by comparing the regions Rf and Rt is substantially synonymous with removing the distance value of the flare pixel region Rf whose echo detection timing overlaps with the target pixel region Rt.

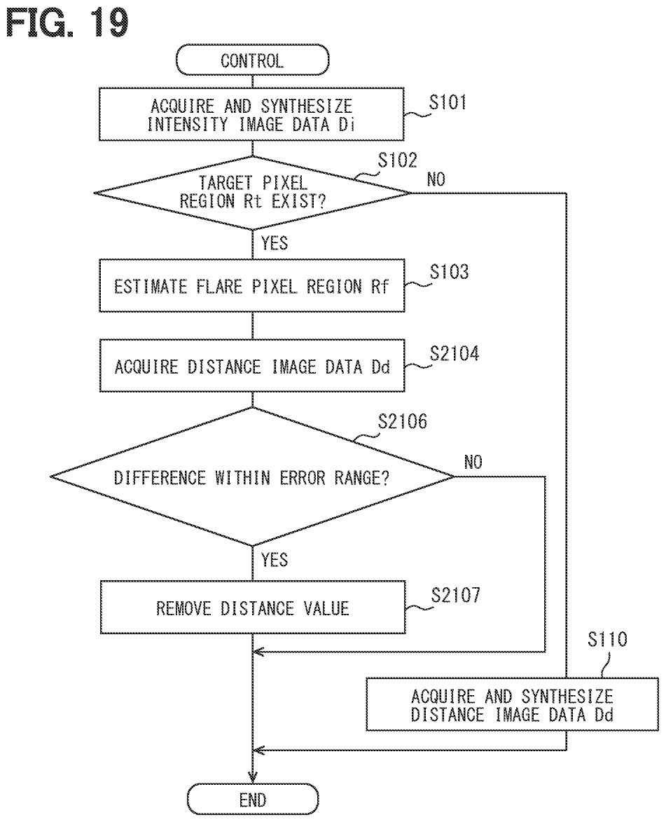

In the control flow of the second embodiment, as shown in FIGS. 19, S2104, S2106, and S2107 are executed instead of S104 to S109 of the first embodiment. In S2104, the distance acquisition block 2100 acquires, for each scanning line Ls with respect to the irradiation light of the first intensity I1, the distance image data Dd for the distance acquisition period Pd of the detection frame Fd, and synthesizes data for the distance acquisition period Pd.

In subsequent S2106, the removal block 2130 determines whether the difference between the estimated distance value of the flare pixel region Rf and the distance value of the target pixel region Rt is within the error range in the synthesized distance image data Dd. When an affirmative determination is made as a result, that is, when there is a distance value of the flare pixel region Rf whose echo detection timing overlaps with the target pixel region Rt, the control flow proceeds to S2107. In S2107, the removal block 2130 removes the distance image data Dd, which is the spurious value in the flare pixel region Rf, in other words, the distance value of the flare pixel region Rf whose echo detection timing overlaps with the target pixel region Rt from the synthesized distance image data Dd. When the execution of S2107 is completed, and when a negative determination is made in S2106, the control flow ends the current execution.

According to the second embodiment, the distance image data Dd is acquired for each of the plurality of scanning lines Ls during the distance acquisition period Pd. On the other hand, the intensity image data Di is acquired for each scanning line Ls during the intensity acquisition period Pi that is earlier than the distance acquisition period Pd. Thereby, it is possible to collectively remove the distance value as the spurious value from the flare pixel region Rf estimated based on the intensity image data Di synthesized for each scanning line Ls for the intensity acquisition period Pi in the distance image data Dd synthesized for each scanning line Ls for the distance acquisition period Pd. Therefore, it is possible to prevent erroneous detection of the distance value by the optical sensor 10.

### Third Embodiment

A third embodiment is another modification of the first embodiment.

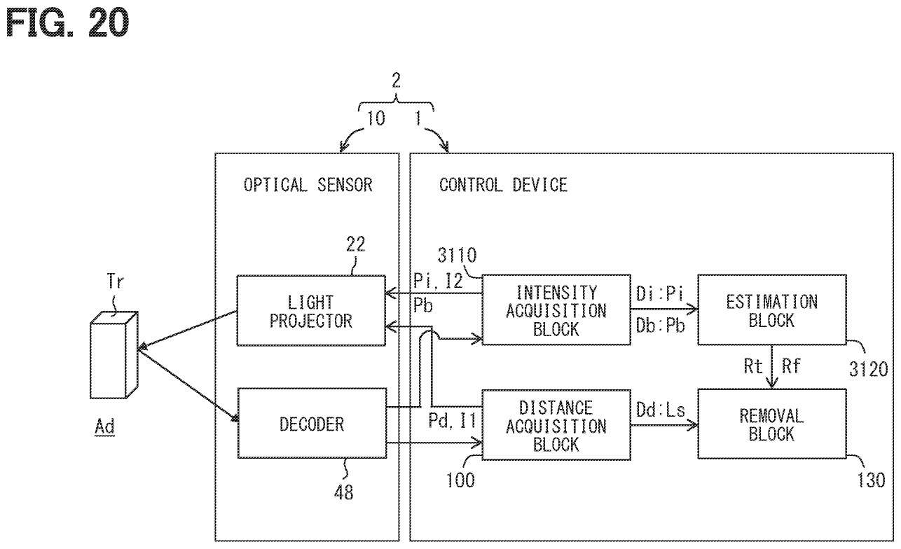

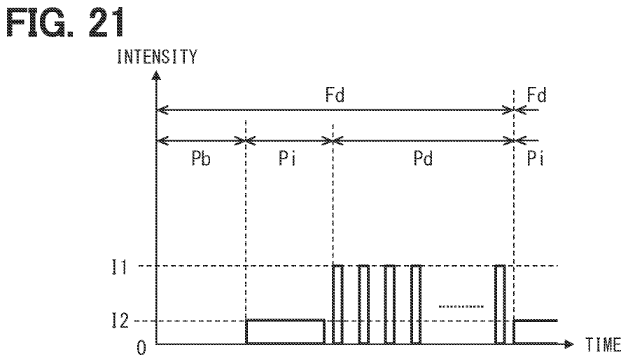

An intensity acquisition block 3110 of the third embodiment shown in FIG. 20 sets, in the detection frame Fd, a background light acquisition period Pb before or after (before in an example of FIG. 21) the intensity acquisition period Pi in which the intensity image data Di is acquired as shown in FIG. 21. Therefore, during the background light acquisition period Pb, the intensity acquisition block 3110 controls the optical sensor 10 to a stop mode in which the application of current is stopped and each laser diode 24 is in a non-light emission state.

As shown in FIG. 20, the intensity acquisition block 3110 acquires two-dimensional background light image data Db representing the intensity value of reflection from the reflective target Tr in the detection area Ad based on the echo detected by the optical sensor 10 with respect to the background light at the non-irradiation time according to the stop mode. At this time, the intensity of the background light is lower in the near-infrared region than the first intensity I1 of the illumination light. In other words, the first intensity I1 described in the first embodiment is set to be higher than the intensity of background light in the near-infrared region.

Along with the acquisition of the background light image data Db, the intensity acquisition block 3110 also controls the rotational drive of the scanning mirror 32 by the scanning motor 35. Then, the intensity acquisition block 3110 generates the background light image data Db for each scanning line Ls according to the rotation angle of the scanning mirror 32, and therefore can synthesize the background light image data Db for each scanning line Ls during the background light acquisition period Pb.

In each scanning line Ls acquired in such a manner and the synthesized background light image data Db, the vertical direction corresponds to the Y-axis direction of the vehicle 5, and the lateral direction corresponds to the X-axis direction of the vehicle 5. Here, the scanning line Ls of the background light image data Db is set so as to correspond to the scanning line Ls of each of the distance image data Dd and the intensity image data Di in the same way and in a 1:1 ratio.

The estimation block 3120 of the third embodiment extracts the intensity value in the target pixel region Rt searched from the intensity image data Di, among the intensity values represented by the background light image data Db. Therefore, the estimation block 3120 corrects the intensity value in the target pixel region Rt of the intensity image data Di by subtracting the intensity value in the target pixel region Rt of the background light image data Db, and then use it for estimating the flare pixel region Rf.

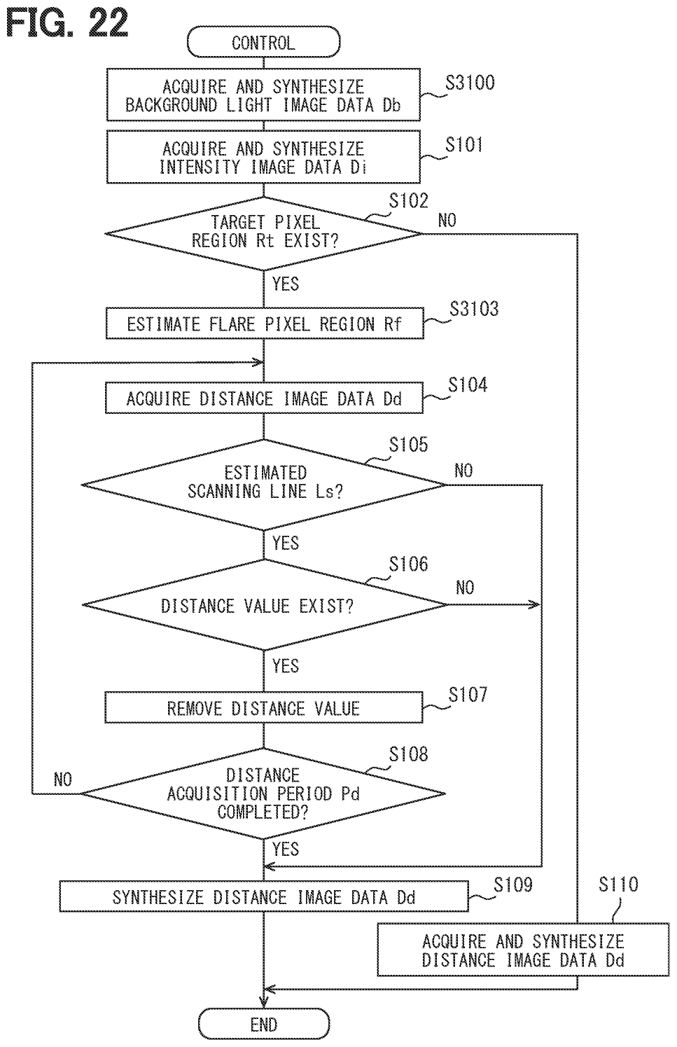

In such a control flow of the third embodiment, as shown in FIG. 22, S3100 is executed before or after (before in the example of FIG. 22) S101 by the intensity acquisition block 3110. In S3100, the intensity acquisition block 3110 acquires the background light image data Db representing the intensity value of the echo from the reflective target Tr for the background light at the non-irradiation time of the irradiation light during the background light acquisition period Pb of the current detection frame Fd. At this time, the background light image data Db for each scanning line Ls are synthesized for the background light acquisition period Pb.

In the control flow of the third embodiment, S3103 is executed instead of S103. In S3013, the estimation block 3120 estimates the flare pixel region Rf of the distance image data Dd based on the intensity value of the target pixel region Rt in the intensity image data Di, the intensity value being corrected by the intensity value of the target pixel region Rt in the background light image data Db.

As described above, according to the third embodiment, the background light image data Db representing the intensity value of the echo reflected from the reflective target Tr in the detection area Ad is acquired based on the echo detected by the optical sensor 10 with respect to the background light in the detection area Ad. Therefore, in the third embodiment, the estimation block 3120 can high accurately estimate the flare pixel region Rf based on the intensity value of the target pixel region Rt in the intensity image data Di, the intensity value being corrected by the intensity value of the target pixel region Rt in the background light image data Db. Thereby, it is possible to accurately remove the distance value of the flare pixel region Rf of which echo detection timing overlaps with the target pixel region Rt in the distance image data Dd, and prevent the erroneous detection of the distance value of the optical sensor 10.

### Fourth Embodiment

A fourth embodiment is a modification of the third embodiment.

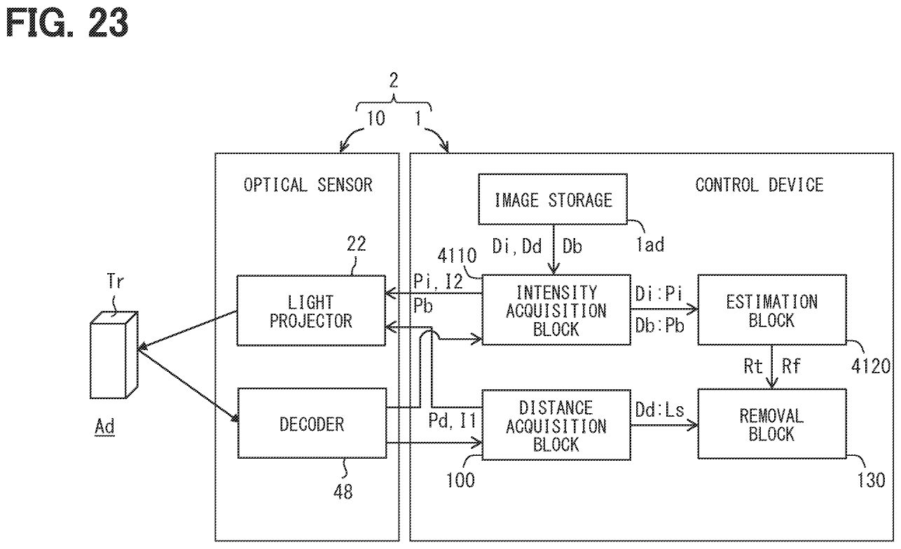

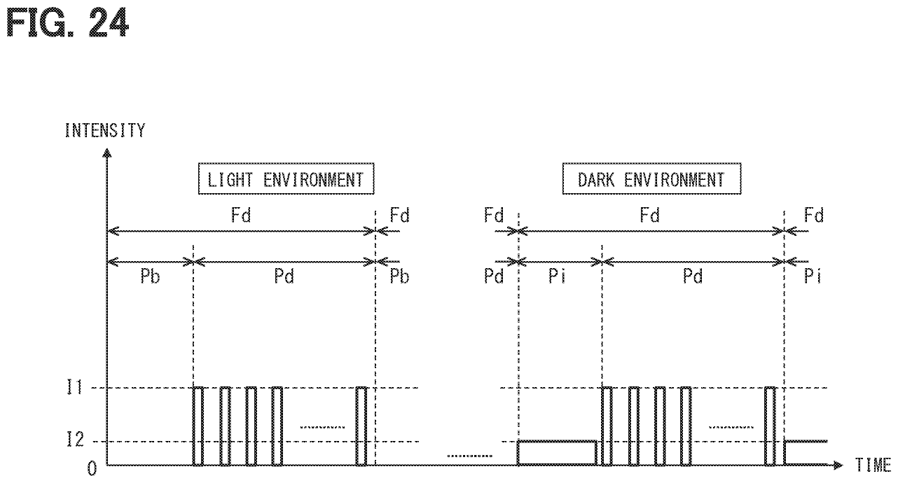

The intensity acquisition block 4110 of the fourth embodiment shown in FIG. 23 switches the period set for each detection frame Fd between the intensity acquisition period Pi and the background light acquisition period Pb according to light and dark of the detection area Ad as shown in FIG. 24. Specifically, the intensity acquisition block 4110 selects the intensity acquisition period Pi so as to acquire the intensity image data Di by controlling the optical sensor 10 to the LED mode in a dark environment such as at night, for example, when the average value or representative value of the background light intensity is less than or equal to a switching threshold.

On the other hand, in a bright environment such as daytime when the average value or representative value of the background light intensity is equal to or greater than the switching threshold, the intensity acquisition block 4110 controls the optical sensor 10 to be in the stop mode and selects the background light acquisition period Pb so as to acquire the background light image data Db. At this time, the background light acquisition period Pb is set before the distance acquisition period Pd in the detection frame Fd. From the above, it can be considered that the background light acquisition period Pb and the background light image data Db are also the intensity acquisition period and intensity image data for the background light.

Here, the background light intensity, which is a reference for switching between the intensity acquisition period Pi and the background light acquisition period Pb, is recognized based on the intensity image data Di and distance image data Dd acquired in the previous detection frame Fd, or based on the background light image data Db acquired in the previous detection frame Fd. At this time, the image data of the previous detection frame Fd is stored in a data storage 1ad shown in FIG. 23 in the memory 1a, and is read out as the background light intensity is recognized. In addition to or in place of such recognition, the background light intensity may be recognized based on sensor information of the vehicle 5.

The estimation block 4120 of the fourth embodiment executes the same process as the estimation block 120 of the first embodiment in the detection frame Fd in which the intensity acquisition period Pi is set. On the other hand, in the detection frame Fd in which the background light acquisition period Pb is set, the estimation block 4120 searches the target pixel region Rt with the imaged reflective target Tr from the background light image data Db synthesized for each scanning line Ls for the background light acquisition period Pb. Here, the fourth embodiment is based on a premise that flare imaging is prevented as much as possible with respect to not only the irradiation light having the second intensity I2 corresponding to the intensity image data Di but also the background corresponding to the background light image data Db. Therefore, according to the estimation block 120 of the first embodiment, the estimation block 4120 estimates the flare pixel region Rf predicted around the target pixel region Rt in the distance image data Dd based on the intensity value of the target pixel region Rt in the background light image data Db. Then, the incident intensity Ii of the echo to the light reception lens system 42 according to the first intensity I1 is estimated from, for example, a representative value or an average value of the intensity value of the target pixel region Rt according to the intensity of the background

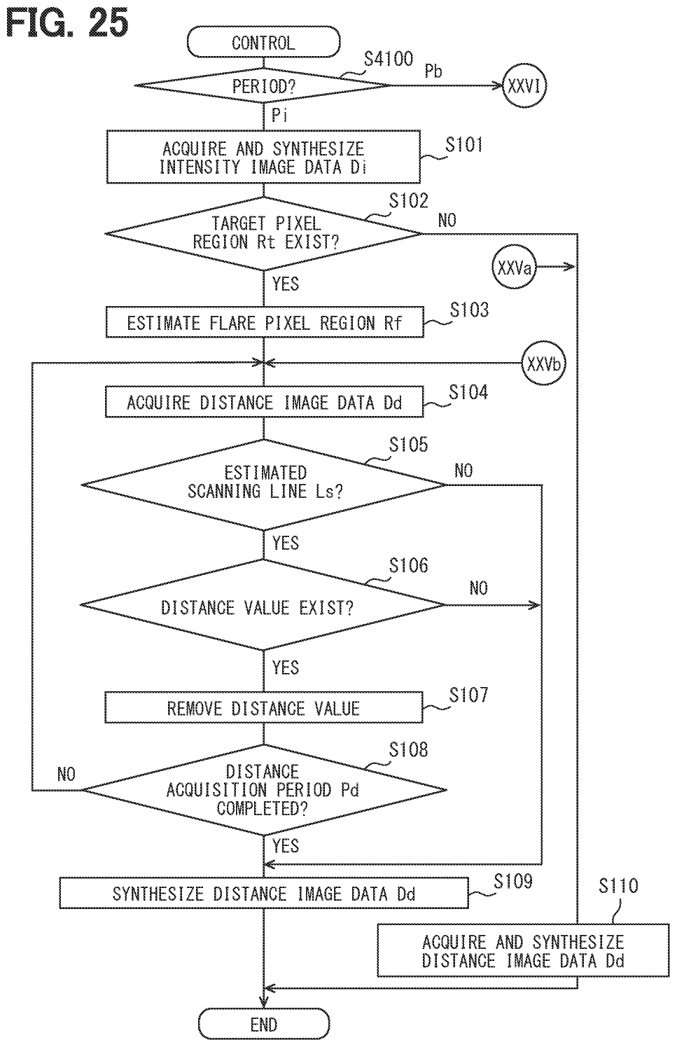

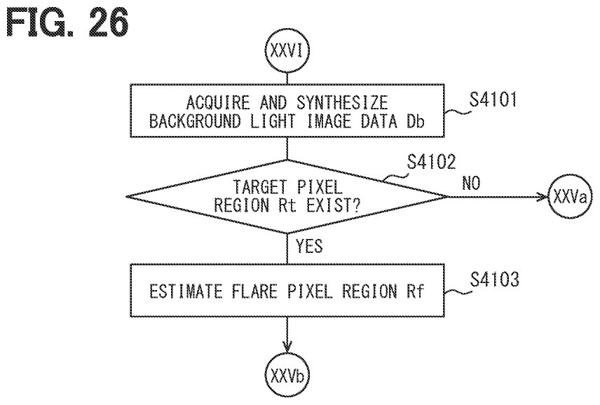

In the control flow of the fourth embodiment, as shown in FIG. 25, S4100 is executed before S101 by the intensity acquisition block 4110. In S4100, the intensity acquisition block 4110 switches the period set for the current detection frame Fd to either the intensity acquisition period Pi or the background light acquisition period Pb, depending on the background light intensity in the detection area Ad. As a result, when the intensity acquisition period Pi is selected by switching, the control flow proceeds to S101, and S101 by the intensity acquisition block 4110 and S102 and S103 by the estimation block 4120 are executed. On the other hand, when the background light acquisition period Pb is selected by switching, the control flow proceeds to S4101 shown in FIG. 26.

In 4101, the intensity acquisition block 4110 acquires the background light image data Db representing the intensity value of the echo from the reflective target Tr for the background light during the background light acquisition period Pb of the current detection frame Fd. At this time, the background light image data Db for each scanning line Ls are synthesized for the background light acquisition period Pb.

In subsequent S4102, the estimation block 4120 determines whether the target pixel region Rt representing an intensity value equal to or greater than the prediction threshold exists in the background light image data Db. As a result, when a negative determination is made, the control flow proceeds to S110 shown in FIG. 25. On the other hand, when an affirmative determination is made as shown in FIG. 26, the control flow proceeds to S4103.

In S4103, the estimation block 4120 estimates the flare pixel region Rf of the distance image data Dd based on the intensity value of the target pixel region Rt in the background light image data Db. At this time, the flare pixel region Rf is estimated in a range Ef that correlates with the optical characteristic Os of the light reception lens system 42 and the intensity value of the target pixel region Rt in the background light image data Db. When the execution of S4103 is completed, the control flow proceeds to S104 shown in FIG. 25, as in the case where S103 is completed.

Also in the fourth embodiment, the distance image data Dd representing the distance value to the reflective target Tr that reflects light in the detection area Ad is acquired based on the echo detected by the optical sensor 10 with respect to the irradiation light. Therefore, in the fourth embodiment, based on the echoes detected by the optical sensor 10 with respect to the background light lower than the irradiation light in the detection area Ad, the background light image data Db is acquired as three intensity image data representing the intensity of the echo reflected from the reflective target Tr in the detection area Ad. Thereby, it is possible to perform appropriate estimation since the flare pixel region Rf of which flare imaging is predicted around the target pixel region Rt with the imaged reflective target Tr in the distance image data Dd is based on the background light image data Db of which imaging is prevented according to the background light with the low intensity. Therefore, it is possible to remove, as the spurious value due to the flare imaging, the distance value of the flare pixel region Rf of which echo detection timing overlaps with the target pixel region Rt in the distance image data Dd, and therefore prevent the erroneous detection of the distance value of the optical sensor 10.

According to the fourth embodiment, the flare pixel region Rf is estimated in a range Ef that correlates with the optical characteristic Os of the light reception lens system 42 forming the image of the echo in the optical sensor 10 and the intensity value of the target pixel region Rt in the background light image data Db as the intensity image data. Thereby, it is possible to appropriately estimate the flare pixel region Rf in which flare imaging is predicted in the range Ef according to the optical characteristic Os around the target pixel region Rt that can be specified from the intensity value of the background light image data Db. Therefore, it is possible to accurately remove the distance value of the flare pixel region Rf of which echo detection timing overlaps with the target pixel region Rt in the distance image data Dd, and prevent the erroneous detection of the distance value of the optical sensor 10.

According to the fourth embodiment, the distance image data Dd is acquired for each of the plurality of scanning lines Ls during the distance acquisition period Pd. On the other hand, the background light image data Db is acquired for each scanning line Ls during the background light acquisition period Pb that is the intensity acquisition period and is earlier than the distance acquisition period Pd. Thereby, based on the background light image data Db synthesized for each scanning line Ls for the background light acquisition period Pb, it is possible to remove the distance value as the spurious value from the distance image data Dd limited to the estimated scanning line Ls in which the flare pixel region Rf has been estimated. Therefore, it is possible to prevent erroneous detection of the distance value by the optical sensor 10.

### Other Embodiments

Although multiple embodiments have been described above, the present disclosure is not construed as being limited to those embodiments, and can be applied to various embodiments and combinations within a scope that does not depart from the spirit of the present disclosure.

The dedicated computer that configures the control device 1 in the modification may be a computer other than the vehicle 5, which configures an external center or a mobile terminal that can communicate with the vehicle 5, for example. The dedicated computer constituting the control device 1 may include at least one of a digital circuit or an analog circuit as a processor. The digital circuit is at least one type of, for example, an application specific integrated circuit (ASIC), a field programmable gate array (FPGA), a system on a chip (SOC), a programmable gate array (PGA), a complex programmable logic device (CPLD), and the like. In addition, such a digital circuit may include a memory storing a program.

In the optical sensor 10 of the modification, the scanning of the detection area Ad by the irradiation light is substantially limited to scanning in the vertical direction. In this case, the long sides of the rectangular outline of the light projection window 25 and the light receiving surface 47 may be defined along the X axis. Further, in this case, the scanning lines Ls regarding each of the image data Dd and Di may be set as pixel columns in the lateral direction corresponding to the X-axis direction, and in a plurality of columns in the vertical direction corresponding to the Y-axis direction. In the optical sensor 10 of the modification, the light projector 22 that emits the irradiation light with the first intensity I1 and the light projector 22 that irradiates the irradiation light with the second intensity I2 may be provided separately. In this case, a light emitting diode (LED) may be used instead of the laser diode 24 as the projector 22 that emits the irradiation light of the second intensity I2.

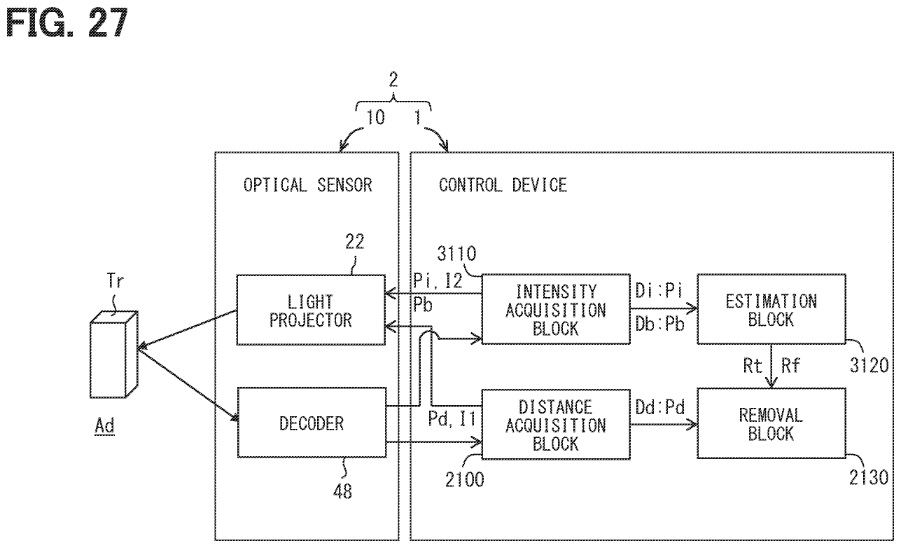

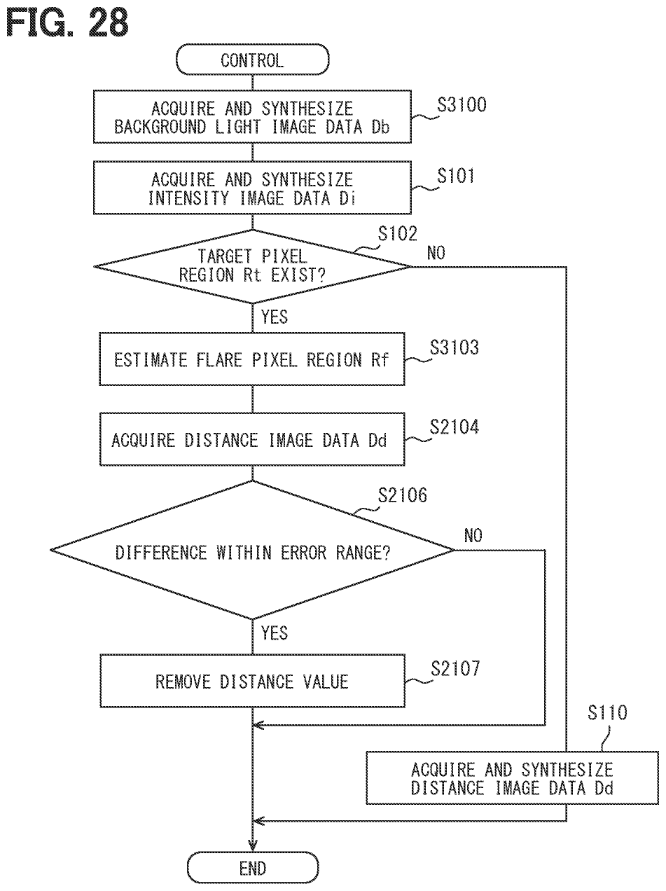

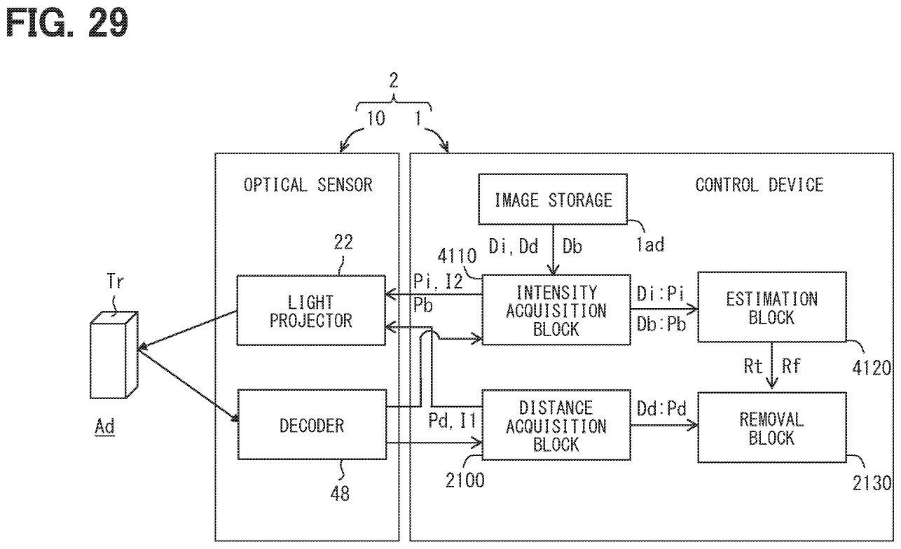

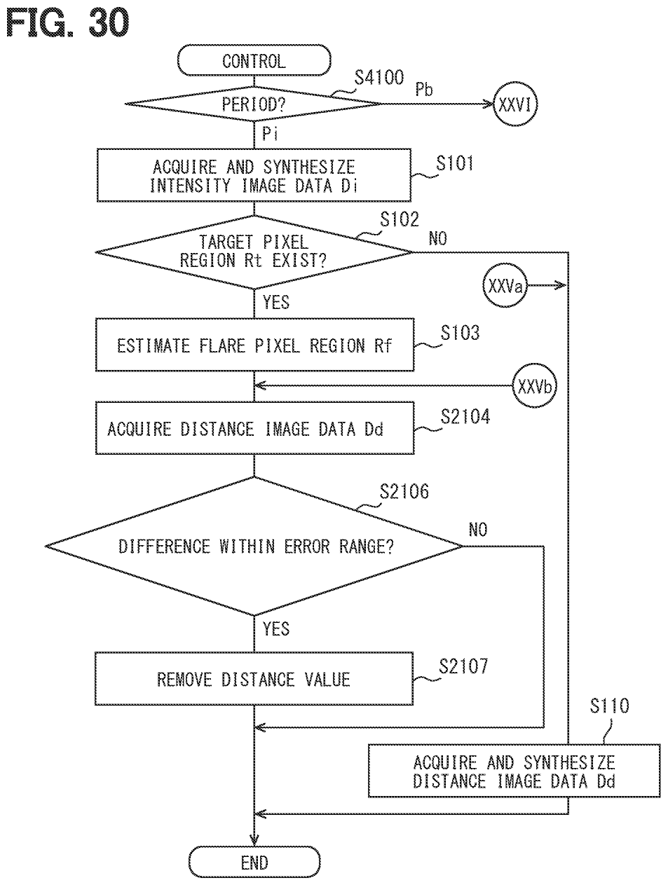

As shown in FIGS. 27 and 28, in the modification, blocks 2100, 2130 and S2104, S2106, S2107 of the second embodiment may be implemented in the third embodiment instead of blocks 100, 130 and S104 to S109. As shown in FIGS. 29 and 30, in the modification, blocks 2100, 2130 and S2104, S2106, S2107 of the second embodiment may be implemented in the fourth embodiment instead of blocks 100, 130 and S104 to S109.

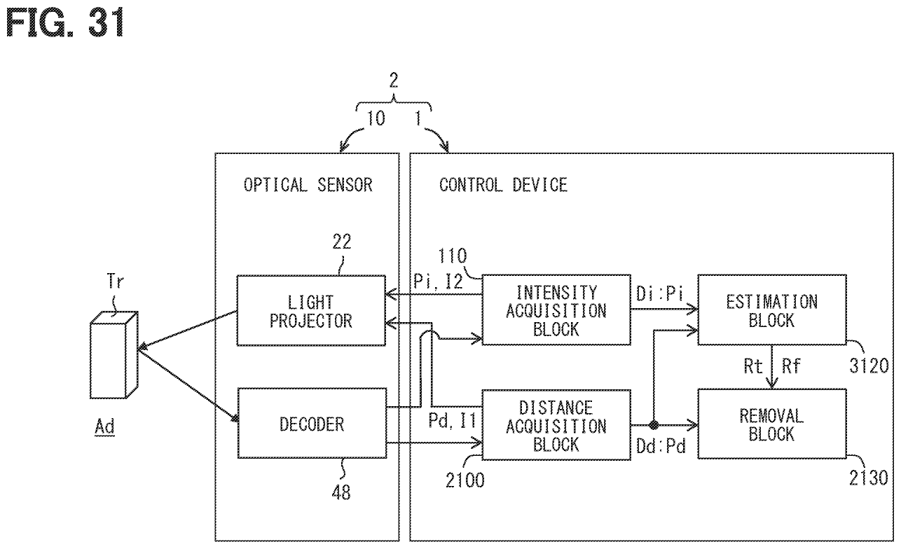

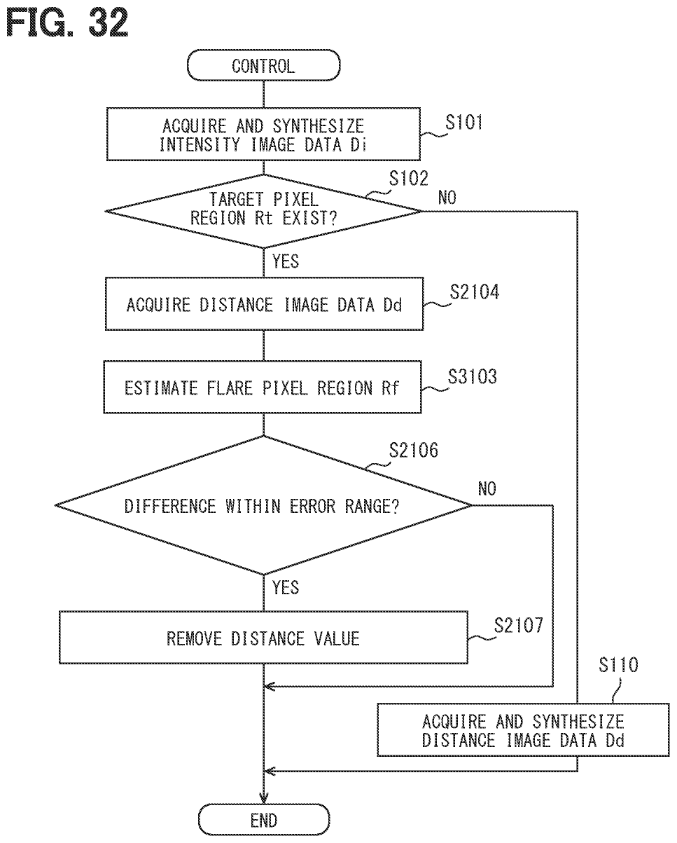

As shown in FIGS. 31 and 32, in the modification, the estimation block 3120 and S3103 of the third embodiment may be implemented in the second embodiment instead of the block 120 and S103. However, in S3103 by the estimation block 3120 in this case, the flare pixel region Rf of the distance image data Dd may be estimated based on the intensity value of the intensity image data Di from which the background light intensity is subtracted by a comparison algorithm with the intensity value of the distance image data Dd regarding the target pixel region Rt. Therefore, S3103 by the estimation block 3120 is executed subsequent to S2104 by the distance acquisition block 2100, so that the distance image data Dd may be acquired so as to include the intensity value of the echo from the reflective target Tr for the irradiation light of the first intensity I1.

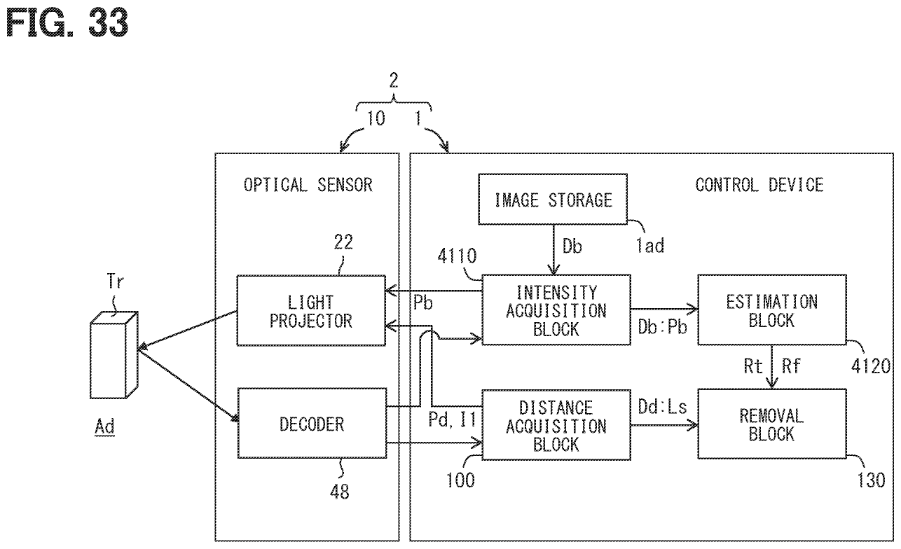

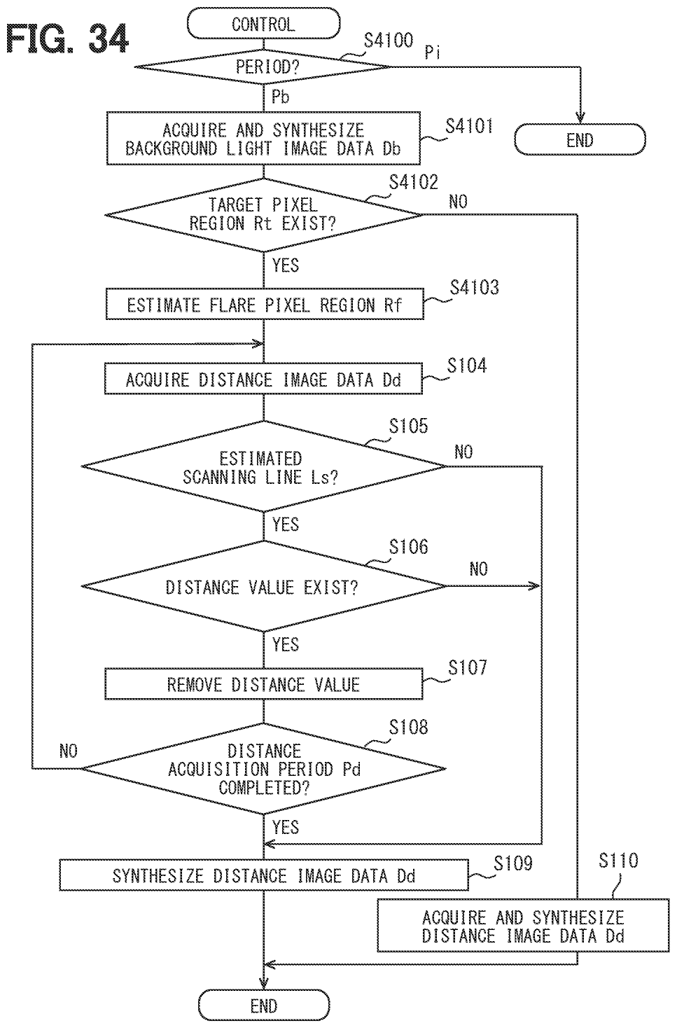

In the modification shown in FIGS. 33 and 34, S101 to S103 by blocks 4110 and 4120 may not be executed. However, in this case, when the intensity acquisition period Pi is selected by switching, the current execution of the control flow ends. In S103, S3013, and S4103 by the estimation blocks 120, 3120, and 4120 of the modification, the flare pixel region Rf may be estimated to be a fixed range Ef around the target pixel region Rt. In this case, it is possible to remove the pseudo value from the flare pixel region Rf in the fixed range Ef where the probability of flare occurrence is high.

In the modification, the vehicle to which the control device 1 is applied may be, for example, an autonomous traveling vehicle that can remotely control travel on a travel route from an external center. In addition to the embodiments described so far, the embodiments and modifications described above may be executed as a semiconductor device (for example, a semiconductor chip or the like) having at least one processor 1b and at least one memory 1a.

1. A control device comprising:
a processor having a memory storing computer program code, wherein the processor having the memory is configured to cause the control device to:
control an optical sensor that detects an echo of irradiation light irradiated to a detection area of a vehicle;
acquire distance image data representing a distance value to a reflective target that reflects light in the detection area based on the echo that is detected by optical sensor and is an echo of the irradiation light with a first intensity;
acquire intensity image data representing an intensity value of the echo reflected from the reflective target in the detection area based on the echo that is detected by the optical sensor and is an echo of the irradiation light with a second intensity lower than the first intensity;
estimate a flare pixel region in which flare imaging is predicted in a periphery of a target pixel region in which the reflective target is imaged in the distance image data, based on the intensity image data; and
remove the distance value of the flare pixel region, wherein a detection timing of the echo in the flare pixel region overlaps with a detection timing of the echo in the target pixel region in the distance image data.

2. The control device according to claim 1, wherein
acquisition of the distance image data includes acquisition of the distance image data for the irradiation light with the first intensity by a laser diode controlled to be in an oscillation state in the optical sensor, and
acquisition of the intensity image data includes acquisition of the intensity image data for the irradiation light with the second intensity by the laser diode controlled to be in a non-oscillation state in the optical sensor.

3. The control device according to claim 1, wherein
the processor is further configured to cause the control device to acquire background light image data representing an intensity value of the echo reflected from the reflective target in the detection area based on the echo that is detected by the optical sensor and is an echo of background light,
estimation of the flare pixel region includes estimation of the flare pixel region based on an intensity value of the target pixel region in the intensity image data, the intensity value being corrected by an intensity value of the target pixel region in the background light image data.

4. A control device comprising:
a processor having a memory storing computer program code, wherein the processor having the memory is configured to cause the control device to:
control an optical sensor that detects an echo of irradiation light irradiated to a detection area of a vehicle;
acquire distance image data representing a distance value to a reflective target that reflects light in the detection area based on the echo that is detected by optical sensor and is an echo of the irradiation light;
acquire intensity image data representing an intensity value of the echo reflected from the reflective target in the detection area based on the echo that is detected by the optical sensor and is an echo of background light with a lower intensity than the irradiation light;
estimate a flare pixel region in which flare imaging is predicted in a periphery of a target pixel region in which the reflective target is imaged in the distance image data, based on the intensity image data; and
remove the distance value of the flare pixel region, wherein a detection timing of the echo in the flare pixel region overlaps with a detection timing of the echo in the target pixel region in the distance image data.

5. The control device according to claim 1, wherein
estimation of the flare pixel region includes estimation of the flare pixel region in a range that correlates with an optical characteristic of a lens system configured to form the echo in the optical sensor and the intensity value of the target pixel region in the intensity image data.

6. The control device according to claim 1, wherein
acquisition of the distance image data includes acquisition of the distance image data for each of a plurality of scanning lines for a distance acquisition period,
acquisition of the intensity image data includes acquisition of the intensity image data for each of the plurality of scanning lines for an intensity acquisition period before the distance acquisition period,
estimation of the flare pixel region includes estimation of the flare pixel region based on the intensity image data synthesized for each of the plurality of scanning lines for the intensity acquisition period,
removal of the distance value includes removal of the distance value of the flare pixel region in the distance image data of a scanning line of the estimated flare pixel region among the plurality of the scanning lines.

7. The control device according to claim 1, wherein
acquisition of the distance image data includes acquisition of the distance image data for each of a plurality of scanning lines for a distance acquisition period,
acquisition of the intensity image data includes acquisition of the intensity image data for each of the plurality of scanning lines for an intensity acquisition period before the distance acquisition period,
estimation of the flare pixel region includes estimation of the flare pixel region based on the intensity image data synthesized for each of the plurality of scanning lines for the intensity acquisition period,
removal of the distance value includes removal of the distance value of the flare pixel region in the distance image data synthesized for each of the plurality of scanning lines for the distance acquisition period.

8. The control device according to claim 1, wherein
the processor is further configured to store, in the memory, the distance image data from which the distance value of the flare pixel region is removed.

9. A control method executed by a processor having a memory storing computer program code, wherein the processor having the memory is configured to control an optical sensor that detects an echo of irradiation light irradiated to a detection area of a vehicle, the control method comprising:
acquiring distance image data representing a distance value to a reflective target that reflects light in the detection area based on the echo that is detected by optical sensor and is an echo of the irradiation light with a first intensity;
acquiring intensity image data representing an intensity of the echo reflected from the reflective target in the detection area based on the echo that is detected by the optical sensor and is an echo of the irradiation light with a second intensity lower than the first intensity;
estimating a flare pixel region in which flare imaging is predicted in a periphery of a target pixel region in which the reflective target is imaged in the distance image data, based on the intensity image data; and
removing the distance value of the flare pixel region, wherein a detection timing of the echo in the flare pixel region overlaps with a detection timing of the echo in the target pixel region in the distance image data.

10. A control method executed by a processor having a memory storing computer program code, wherein the processor having the memory is configured to control an optical sensor that detects an echo of irradiation light irradiated to a detection area of a vehicle, the control method comprising:
acquiring distance image data representing a distance value to a reflective target that reflects light in the detection area based on the echo that is detected by optical sensor and is an echo of the irradiation light;
acquiring intensity image data representing an intensity value of the echo reflected from the reflective target in the detection area based on the echo that is detected by the optical sensor and is an echo of background light with a lower intensity than the irradiation light;
estimating a flare pixel region in which flare imaging is predicted in a periphery of a target pixel region in which the reflective target is imaged in the distance image data, based on the intensity image data; and
removing the distance value of the flare pixel region, wherein a detection timing of the echo in the flare pixel region overlaps with a detection timing of the echo in the target pixel region in the distance image data.

11. A non-transitory computer-readable storage medium storing a control program storing computer program code that when executed by a processor cause the processor to:
control an optical sensor that detects an echo of irradiation light irradiated to a detection area of a vehicle;
acquire distance image data representing a distance value to a reflective target that reflects light in the detection area based on the echo that is detected by optical sensor and is an echo of the irradiation light with a first intensity;
acquire intensity image data representing an intensity of the echo reflected from the reflective target in the detection area based on the echo that is detected by the optical sensor and is an echo of the irradiation light with a second intensity lower than the first intensity;
estimate a flare pixel region in which flare imaging is predicted in a periphery of a target pixel region in which the reflective target is imaged in the distance image data, based on the intensity image data; and
remove the distance value of the flare pixel region, wherein a detection timing of the echo in the flare pixel region overlaps with a detection timing of the echo in the target pixel region in the distance image data.

12. A non-transitory computer-readable storage medium storing a control program storing computer program code that when executed by a processor cause the processor to:
control an optical sensor that detects an echo of irradiation light irradiated to a detection area of a vehicle;
acquire distance image data representing a distance value to a reflective target that reflects light in the detection area based on the echo that is detected by optical sensor and is an echo of the irradiation light;
acquire intensity image data representing an intensity value of the echo reflected from the reflective target in the detection area based on the echo that is detected by the optical sensor and is an echo of background light with a lower intensity than the irradiation light;
estimate a flare pixel region in which flare imaging is predicted in a periphery of a target pixel region in which the reflective target is imaged in the distance image data, based on the intensity image data; and
remove the distance value of the flare pixel region, wherein a detection timing of the echo in the flare pixel region overlaps with a detection timing of the echo in the target pixel region in the distance image data.
